(19) United States
(12) Patent Application Publication
(10) Pub. No.: US 2025/0250129 A1
(43) Pub. Date: Aug. 7, 2025

(54) LINEAR DRIVE CONVEYANCE SYSTEM (LDCS)

(71) Applicant: Terrament, Inc., Brooklyn, NY (US)

(72) Inventor: Eric Chaves, Brooklyn, NY (US)

(21) Appl. No.: 19/189,711

(22) Filed: Apr. 25, 2025

Related U.S. Application Data
(63) Continuation of application No. PCT/US2023/078047, filed on Oct. 27, 2023.
(60) Provisional application No. 63/419,936, filed on Oct. 27, 2022.

(51) Int. Cl. B65G 54/02

(52) U.S. Cl. CPC B65G 54/02

(57) ABSTRACT

A linear drive conveyance system including a rack having a first end and a second end, defining a longitudinal axis therebetween, the rack having an undulating surface having a plurality of alternating arcuate peaks and valleys spaced along the longitudinal axis, a finger opposing the undulating surface, the finger having cylindrical head disposed perpendicular to the longitudinal axis, a follower abutting perpendicularly to and at a midpoint of the cylindrical head a cam disposed opposite of the follower from the cylindrical head, the cam having an asymmetrical cam profile, the cam configured to rotate about a cam axis extending perpendicularly to and spaced from the longitudinal axis and a camshaft rigidly coupled to the cam, the camshaft extending along the longitudinal axis.

### CROSS REFERENCE TO RELATED APPLICATIONS

This application is a Continuation of International App. No. PCT/US23/78047, filed on Oct. 27, 2023, which claims the benefit of U.S. Provisional Pat. App. No. 63/419,936, filed on Oct. 27, 2022, the entire contents of which are hereby incorporated by reference in their entirety.

### BACKGROUND OF THE DISCLOSED SUBJECT MATTER

### Field of the Disclosed Subject Matter

The disclosed subject matter relates to linear drive conveyance systems. Particularly, the present disclosed subject matter is directed to linear drive conveyance systems within a gravity powered energy storage system.

### Description of Related Art

There is a fast growing demand for large-scale energy storage which is needed to support renewable energy and therefore to help mitigate the risks of climate change. Energy markets around the world are already replacing carbon-based fuels with renewable energy sources. However, one of the largest obstacles to this growing development of renewable energy is that we lack enough energy storage to compensate for the variability of weather dependent energy generation. Simply put, the sun doesn't always shine and the wind doesn't always blow. This will become an increasingly large problem as renewable energy becomes a larger percentage of our power grid. To solve this problem, we need cheaper and more efficient energy storage solutions.

This disclosed subject matter provides such a solution on a large scale. This solution both solves a fast growing market need and also helps mitigate the dangers of climate change. The following patents disclose various systems and devices for energy storage: U.S. Pat. No. 7,944,075 to Boone discloses a wind turbine-based energy storage system and method using heavy weighted devices. The Boone patent discloses an energy storage system, and related method, comprising a plurality of wind turbines, each with a vertical shaft that passes through a support platform. One or more braces may be affixed to each vertical shaft at one end of this platform, at an angle of less than 60 degrees, preferably about 45 degrees. At least one heavily weighted device is configured and disposed to be raised with rotation of the wind turbine about its vertical shaft. The subsequent lowering of that weighted device generates electrical energies for immediate use. Alternatively, the weighted device may be suspended for storage of energy and subsequent use. Preferred embodiments include at least one energy storage system for holding excess unused energy. Representative devices include a weighted cylinder on a shaft or cable, and one or more railcars on a series of inclined tracks.

U.S. Pat. No. 7,281,371 to Heidenreich discloses a compressed air pumped hydro energy storage and distribution system, the entire contents of which are hereby incorporated herein. The Heidenreich patent includes a first reservoir of water and a second reservoir of air and water. An air pressure source, connected to the second reservoir, develops a pressure head in the second reservoir. A pump/turbine-motor/generator, received by the first reservoir, is connected to a regional energy grid. During peak demand periods, the pressure head forces water through the pump/turbine-motor/generator to generate power, delivered to the grid. During low demand periods, the pump/turbine-motor/generator pumps water back to the second reservoir, regenerating the pressure head. A third air reservoir interconnected with the second reservoir and a gas turbine generator can be used to generate power during peak demand periods. The reservoirs can be tunnels or abandoned mines, reinforced and sealed by pressure grouting and/or an internal liner, maintained well beneath the earth's surface and intersecting the path of the grid.

U.S. Pat. No. 9,869,291 to Fiske discloses a system and method for storing energy, the entire contents of which are hereby incorporated herein. The Fiske patent discloses a system for storing energy which includes a body and a shaft having walls defining an internal volume for containing a fluid, a seal member disposed between the body and the walls of the shaft, and a fluid passage in fluid communication with the shaft. The body is disposed within the internal volume of the shaft for movement with gravity from a first elevation position to a second elevation position within the internal volume of the shaft. The seal member divides the internal volume into a first portion located below the body and a second portion located above the body. The fluid passage communicates fluid with the first portion of the interior volume of the shaft. The system further includes a pump/turbine operatively coupled with the fluid passage to drive a motor/generator to generate electricity upon movement of the body from the first elevation position to the second elevation position.

U.S. Pat. No. 9,726,159 to Littman discloses units and methods for energy storage, the entire contents of which are hereby incorporated herein. The Littmann patent discloses a system for storing energy that includes a body and a shaft having walls defining an internal volume for containing a fluid, a seal member disposed between the body and the walls of the shaft, and a fluid passage in fluid communication with the shaft. The body is disposed within the internal volume of the shaft for movement with gravity from a first elevation position to a second elevation position within the internal volume of the shaft. The seal member divides the internal volume into a first portion located below the body and a second portion located above the body. The fluid passage communicates fluid with the first portion of the interior volume of the shaft. The system further includes a pump/turbine operatively coupled with the fluid passage to drive a motor/generator to generate electricity upon movement of the body from the first elevation position to the second elevation position.

Nonetheless, despite the ingenuity of the above systems and devices, there remains a need for improved energy storage systems that can efficiently store large amounts of electric power and release it back into the power grid when needed.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a linear drive conveyance system, the system including a rack having a first end and a second end, defining a longitudinal axis therebetween, the rack having at least one undulating surface, the undulating surface having a plurality of alternating arcuate peaks and valleys spaced along the longitudinal axis, a finger opposing the undulating surface of the rack, the finger having cylindrical head disposed perpendicular to the longitudinal axis, the cylindrical head having two planar ends circumscribed by a cylindrical sidewall, at least one pin extending from each of the planar ends of the cylindrical head, a follower having a cylindrical sidewall abutting perpendicularly to and at a midpoint of the cylindrical head, a cam disposed opposite of the follower from the cylindrical head, the cam having an asymmetrical cam profile, the cam configured to rotate about a cam axis extending perpendicularly to and spaced from the longitudinal axis and a camshaft rigidly coupled to the cam, the camshaft extending along the longitudinal axis.

To achieve these and other advantages and in accordance with the purpose of the disclosed subject matter, as embodied and broadly described, the disclosed subject matter includes a linear drive conveyance system, the system including a first and a second rack, each rack having a first end and a second end, defining a longitudinal axis therebetween an undulating surface having a plurality of alternating peaks and valleys spaced along the longitudinal axis, and a planar surface disposed opposite the undulating surface, wherein each rack is affixed to an adjacent rack along the planar surface, a first and a second plurality of fingers, each plurality of fingers disposed opposite each of the undulating surfaces and extending along the longitudinal axis, each finger having a cylindrical head disposed perpendicular to the longitudinal axis, the cylindrical head having two planar ends circumscribed by a cylindrical sidewall, at least one pin extending from each of the planar ends of the cylindrical head, a follower having a cylindrical sidewall abutting perpendicularly to and at a midpoint of the cylindrical head, a first and a second plurality of cams, each plurality of cams disposed opposite the followers from the cylindrical heads, each cam having an asymmetrical cam profile, each plurality of cams disposed along cam axes oppositely spaced from and parallel to the longitudinal axis outward from the undulating surfaces and a camshaft rigidly coupled to each plurality of cams, each camshaft extending along the cam axes.

To achieve these and other advantages and in accordance with the purpose of the disclosed subject matter, as embodied and broadly described, the disclosed subject matter includes a linear drive conveyance system, the system including a rack having a first end and a second end, defining a longitudinal axis therebetween, the rack having at least one undulating surface, the undulating surface having a plurality of alternating arcuate peaks and valleys spaced along the longitudinal axis, at least one finger, each finger having a cylindrical head disposed perpendicular to the longitudinal axis, the cylindrical head having two planar ends circumscribed by a cylindrical sidewall, at least one pin extending from each of the planar ends of the cylindrical head, an extendable piston coupled to a midpoint of the cylindrical head, the extendable piston extending perpendicular to the cylindrical head and the longitudinal axis, a first hydraulic manifold disposed on a first lateral side of the at least one fingers and extending in parallel to the longitudinal axis, the first hydraulic manifold in fluid communication with the extendable piston of the at least one finger and a second hydraulic manifold disposed on a second lateral side of the at least one finger and extending parallel to the longitudinal axis, the second hydraulic manifold in fluid communication with the extendable piston, wherein the at least one finger is rotatably coupled to the first and the second hydraulic manifolds.

To achieve these and other advantages and in accordance with the purpose of the disclosed subject matter, as embodied and broadly described, the disclosed subject matter includes a linear drive conveyance system, the system including a weight module having a first end and a second end, defining a longitudinal axis therebetween, the weight module having at least one planar surface extending from the first end to the second end, a bearing channel having a first wall having extending a first distance from the at least one planar surface and a second wall spaced from the first wall, the second wall extending parallel to the first wall along the longitudinal axis, a plurality of stationary bearings, each stationary bearings including a cylindrical sidewall disposed proximate at least one of the first wall and the second wall, the cylindrical sidewall extending along the first distance from the planar surface of the weight module, wherein the plurality of stationary bearings extending along the longitudinal axis, a plurality of moveable bearings, each moveable bearing including a cylindrical sidewall disposed inward of the plurality of stationary bearings, the cylindrical sidewall extending parallel to the plurality of stationary bearings and between adjacent stationary bearings along the longitudinal axis, and a belt extending along the longitudinal axis between the first wall and the second wall of the bearing channel, the belt disposed between the plurality of movable bearings, the belt having a plurality of bulges periodically disposed along the belt, the bulges having a bulge thickness greater than the belt, wherein the plurality of bulges configured to contact the plurality of moveable bearings as the belt translates along the longitudinal axis.

To achieve these and other advantages and in accordance with the purpose of the disclosed subject matter, as embodied and broadly described, the disclosed subject matter includes a linear drive conveyance system, the system including a bearing channel having a first wall having extending a first distance from the at least one planar surface and a second wall spaced from the first wall, the second wall extending parallel to the first wall along the longitudinal axis, a first toothed section having a first plurality of teeth coupled to the first wall and extending along the longitudinal axis, the first plurality of teeth facing the an interior of the bearing channel, a second toothed section having a plurality of teeth coupled to the second wall extending along the longitudinal axis, the second plurality of teeth disposed opposite and facing the first plurality of teeth, a toothed belt extending between the first wall and the second wall, the toothed belt having a first planar side facing the first wall and a second planar side facing the second wall, the toothed belt having lateral planar edges, the toothed belt having a first plurality of belt teeth disposed on the first planar side and a second plurality of belt teeth disposed on the second planar side, a plurality of roller bearings periodically disposed on the lateral planar edges sides of the toothed belt, a plurality of slotted sections extending from the first wall to the second wall, each slotted section having a slot disposed between the first wall and the second wall configured to retain one of the plurality of roller bearings and at least two drivers, each driver disposed proximate at least one of the first wall and the second wall, each driver having at least one wheel in contact with the first or second wall and the toothed belt, wherein the at least two drivers are configured to translate along the longitudinal axis, thereby forcing the toothed belt to mesh with the first and the second toothed sections in an alternating pattern.

To achieve these and other advantages and in accordance with the purpose of the disclosed subject matter, as embodied and broadly described, the disclosed subject matter includes a linear drive conveyance system, the system including a rack having a first end, a second end, defining a longitudinal axis therebetween, at least one planar surface extending along the longitudinal axis, the at least one planar surface having lateral planar edges, at least one channel disposed in the planar surface, the channel having alternating angular segments, a slotted section, the slotted section having a first end and a second end extending along the longitudinal axis, the slotted section having lateral planar edges disposed interior to the planar edges of the rack, a plurality of slots extending at an angle to the longitudinal axis, the plurality of slots disposed periodically along the slotted section in the longitudinal axis, a plurality of roller bearings disposed within the plurality of slots, each roller bearing having a first end and a second end, with a cylindrical sidewall therebetween, the cylindrical sidewall configured to abut an interior surface of the plurality of slots, wherein the plurality of roller bearings extend from the plurality of slots into the at least one channel of the rack, wherein the slotted section is configured to translate along the longitudinal axis relative to the rack.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIGS. 1-2 are schematic representations of a linear drive conveyance system in accordance with the disclosed subject matter.

FIGS. 3A-3B are schematic representations of a linear drive conveyance system using at least one cam and rotation of said cam relative to a finger in accordance with the disclosed subject matter.

FIGS. 4-5 are schematic representation of a linear drive conveyance system using at least two camshafts in accordance with the disclosed subject matter.

FIGS. 6A-6E are schematic representations of a linear drive conveyance system with one-sided, two-sided cam shafts and load bearing elements in accordance with the disclosed subject matter.

FIGS. 7-9 are schematic representations of a linear conveyance system with hydraulics in accordance with the disclosed subject matter.

FIG. 10 is a schematic representation of a linear conveyance system with linkages in accordance with the disclosed subject matter.

FIG. 11 is a schematic representation of a linear conveyance system utilizing cams and a plurality of linkages in accordance with the disclosed subject matter.

FIG. 12 is a schematic representation of a linear drive conveyance system in accordance with the disclosed subject matter.

FIG. 13 is a schematic representation of a linear drive conveyance system utilizing a rocking motion in accordance with the disclosed subject matter.

FIG. 14A-14C are schematic representations of a linear drive conveyance system utilizing bearing arrays in accordance with the disclosed subject matter.

FIG. 15A-15D are schematic representations of a linear drive conveyance system utilizing a serpentine toothed belt in accordance with the disclosed subject matter.

FIGS. 16A-16C are schematic representations of a linear drive conveyance system utilizing angled channels in accordance with the disclosed subject matter.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

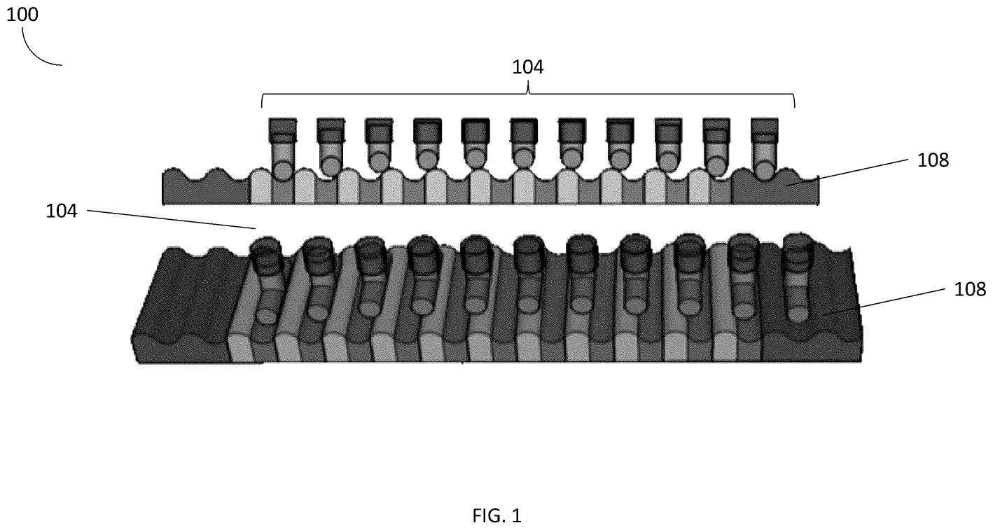

The methods and systems presented herein may be used linear drive conveyance. The disclosed subject matter is particularly suited for a gravity powered energy storage using a linear conveyance system. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

The present disclosed subject matter may be utilized within construction and operation of a gravity powered energy storage facility. This facility might also be called a gravity battery or a gravitational potential energy storage device. In a preferred embodiment, the device converts electricity into gravitational potential energy and vice versa by raising and lowering massive modules between a higher elevation and a lower elevation. These modules could maximize their mass with weight container units consisting of any heavy medium, such as water, stone, metal, concrete, compacted earth, etc.

The disclosed systems described herein may be utilized for linear conveyance of weights configured to generate and store electricity by utilizing one or more weights being acted upon by gravity. This facility might also be called a gravity battery or a gravitational potential energy storage device. In various embodiments, the device converts electricity into gravitational potential energy and vice versa by raising and lowering massive modules between a higher elevation and a lower elevation and/or conveying these components upwards or downwards. These modules could maximize their mass with weight container units consisting of any heavy medium, such as water, stone, metal, concrete, compacted earth, etc.

In various embodiments, the systems described herein may be electrically coupled to one or more power conversion systems connecting the system to the outside grid or a plurality of electric storage mediums, such as electrochemical batteries, for example. The power conversion system can control incoming and outgoing energy between the grid and the installation. In various embodiments, the system may include a weight module or a collection of modular, massive weights, either tethered together in a line or gathered together in some other configuration. If tethered together in a line, the group may be thought of as a train which may run horizontally, vertically, or along any path.

In various embodiments, the systems may be configured to locomote weights between an upper and lower location such as an upper storage location, which could be a suitable area for storing the collection of weights at a high elevation. Note that the term “high” only has meaning relative to the “low” elevation. The high elevation could be at ground level because the lower level could be below ground. This storage location could be a horizontal track comprised of a set of supporting rails at ground level.

In various embodiments, the lower location may be a lower storage location, which is typically a deep vertical shaft dropping to a low elevation. For example, this shaft could be a repurposed mine shaft, or it could be a newly constructed shaft drilled into bedrock.

In various embodiments, each LDCS as described herein may include a mechanism for supporting each section of weight and distributing the aggregated load of the weights to one or more motor/generators. This mechanism can distribute the load in a manner which ensures that no motor/generator is overloaded. It can also optimize the load so that each motor/generator typically operates within its optimal parameters. If the installation is to support a series of weights in a train, the design should be able to scale up to a very large quantity of weights by adding more modules. This implies that it is not possible or not practical to hang all of the tethered weights off of a single supporting tether or a limiting small number of tethers which hold the entire train. Instead, each section of weight should be supported by its own modular supporting component which is also connected to one or more motor/generators in order to support and transmit the gravitational force from the module to those motor/generators. By virtue of this modular design, even if each module of the train were to be physically connected, the force of each module should not greatly impact any of the other modules because each module will be independently supported.

In various embodiments, the lower storage area of the energy storage system may be mined out of bedrock or other earth material, or may be adapted or constructed from the site of an abandoned mine or some other preexisting excavation.

In various embodiments, the upper storage area of the energy storage system may be above ground, external to the vertical shaft, and located so as not to obstruct the movement of other weights from leaving the vertical shaft.

In various embodiments, the upper storage area of the energy storage system may comprise a horizontal rail line placed at ground level similar to a train rail, having weights which are supported by that rail and attached together so that they may be pulled in one continuous motion to facilitate travel to and from the vertical shaft.

In various embodiments, the energy storage system comprises a gear reduction drive mechanism to adjust the ratio between the weights' velocity and the effective force exerted by the motor/generators. By adjusting the velocity of the falling mass, the system can maintain the optimal force on the motor/generators at all times. This mechanism may apply the principles of a variable speed transmission so that the adjustment could be continuous without discrete steps.

The disclosed subject matter may include any linear drive conveyance system (LDCS) which imparts a gear reduction-like effect along a linear direction in which multiple driving components operate primarily through a linear motion instead of a rotational motion. In various embodiments, any LDCS may be configured to exhibit or affect linear motion along a defined longitudinal direction. In various embodiments, any LDCS may include any number of driving components, including embodiments having three interconnected driving components, wherein one or more of the driving components can have array of force-exerting elements (e.g. teeth or cams). In various embodiments, one linear component can be fixed, a second linear component can be configured to moves relatively slowly, and a third linear component can be configured to move more quickly relative to the second linear component. In various embodiments, the relative speeds of the second and third linear components can enable a gear-drive-like exchange of speed for a proportional change of force, and the arrays of force-exerting elements on each linear component may be modulated along a non-longitudinal direction in a wave-like pattern, where the elements of each linear component may interact with the elements of one of more other linear components.

In various embodiments, any linear drive system as described above, each linear drive component can have a longitudinal spacing of elements different from the longitudinal spacing of elements of other linear components such that the elements of two different linear components sometimes align and sometimes do not. In various embodiments, any LDCS described may include alternatingly aligning components relative to the longitudinal direction of the array, the pattern of alignment or misalignment creates a repeating cycle pattern which may form a harmonic interval—that is, an alignment will occur after every n elements where n is an integer dependent on the intentional spacing of the array's elements.

In various embodiments, any LDCS described herein may include one linear component having portions or elements shaped such that they exert one or more forces on the other two linear components in such a way that it mitigates an efficient exchange of force between the modulated force-exerting elements of the other two linear components. In various embodiments, these elements may exert forces on the other linear components such that arrays of force vectors are formed which may have both a longitudinal component and a non-longitudinal component. In various embodiments, the non-longitudinal component can move the plurality of elements in a way that is compatible with their designed degrees of freedom and where the longitudinal component acts upon the linear component to create a linear motion.

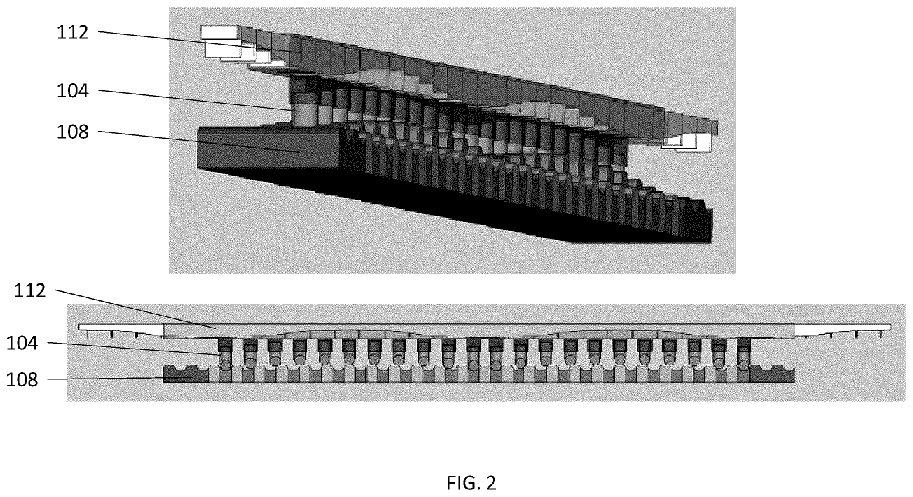

As shown in FIGS. 1 and 2, an LDCS system 100 is shown in a plurality of views. The LDCS 100 may include a plurality of moveable heads 104, hereinafter may interchangeably be called ‘fingers’, ‘effectors’, or the like that move relative to each other, and to a rack 108, which may have a waveform or similarly undulating cross sectional shape. In various embodiments, there may be any number of fingers 104 disposed on an arbitrarily long rack 108, such that there may be any plurality of fingers 104 having a generally similar orientation, spaced from each other at either similar or distinct inter-finger distances. In various embodiments, each finger 104 may be in fluid communication to one another or a common fluid source. In various embodiments, the fingers 104 may be in fluid communication to a distinct fluid source or actuator. In various embodiments, a first portion of the fingers 104 may be coupled to a first actuator and a second portion of fingers 104 may be coupled to a second actuator. In various embodiments, the actuator may be any component which affects motion of the fingers. In various embodiments, the actuators may be an electric motor, stepper motor, hydraulic fluid source, pneumatic fluid source, pump, a piston or plurality of pistons, among others. In various embodiments, the plurality of fingers 104 may be selectively movable relative to one another and the rack 108. In various embodiments, a single finger 104 may be actuated with the other fingers 104 in a rest state or storage state, such as pressed into contact with the rack 108. In various embodiments, the orientation of the fingers 104 and the rack 108 may be oriented in any direction, for example, and as shown, the fingers 104 and the rack 108 may be horizontally disposed. In various embodiments, the fingers 104 and the rack 108 may be vertically disposed, such as disposed in a vertical shaft. In various embodiments, the shaft may be disposed underground and mind from bedrock. In various embodiments, the rack 108 and the fingers 104 may be coupled to bedrock in a shaft disposed underground.

In various embodiments, the plurality of fingers 104 may be coordinated or controlled through one or more methodologies and under the power of various actuators, as described above. In various embodiments the plurality of methodologies may be one or more of hydraulic, pneumatic or mechanical actuation.

In various embodiments, the coordinated actuation of the fingers 104 may be configured to gradually lift or lower (or otherwise direction translate) the rack 108 along the length of the system, such as lifted or lowered in a vertical underground shaft. In various embodiments, the system may be disposed in a portion of a shaft underground as disclosed in U.S. patent application Ser. No. 17/237,048, the entire contents of which are hereby incorporated by reference in their entirety. The height is maximized by digging deep underground—around a mile deep in various embodiments. A mile is much greater than the height of any systems using above-ground tower designs, rail-based solutions, or mountainous terrain solutions. The expense of excavation is cost-effective due to the enormous benefit of the height gained. In some circumstances, an abandoned mine shaft can be utilized to save some construction expense.

In various embodiments, the rack 108 or the fingers 104 may each be coupled or affixed to a weight module or heavy component of another use. The plurality of effectors 104 may display an undulating collective movement configured to pass the rack 108 along the effectors in a first and/or second direction, the second direction being opposite the first direction. The LDCS 100 may be configured to translate the rack 108 and anything affixed thereto in a plurality of directions, such as horizontally, vertically, or at any angle in between. The system may be configured to move the rack 108 in both directions, or a single direction.

In various embodiments, any of the LDCS described herein may be configured to lift and lower weight module within a spiralized shaft. This spiral may be fixed to a shaft wall so that it forms a load-bearing ramp at the edges of the shaft. In various embodiments, multiple instances of said spiral track may be utilized, where each instance can be offset in rotation to form various helical shapes such as a double helix, triple helix, etc. as described in U.S. patent application Ser. No. 17/237,048, the entire contents of which are hereby incorporated by reference in their entirety.

Referring now to FIG. 2, LDCS 100 may include a cammed actuator 112. In various embodiments, the cammed actuator 112 may be disposed substantially along and opposite the rack 108, the cammed actuator 112 disposed proximate shafts of the fingers 104. In various embodiments, translation of the cammed actuator 112 translating along the plurality of fingers 104 may contact each finger 104 with an undulating surface, the undulating surface moving the fingers toward or away from the rack depending on the longitudinal location of the cammed actuator 112. The plurality of fingers 104 may be elastically coupled to the cammed actuator 112 such that when a valley of the cammed actuator 112 is disposed over the finger 104, the finger 104 is retracted towards the valley of the cammed actuator 112. In various embodiments, the cammed actuator 112 may be disposed within a shaft or channel having openings, slots or apertures configured to receive the fingers 104. In various embodiments, the cammed actuator 112 may translate relative to the stationary shaft and stationary fingers 104. In various embodiments, a cammed actuator 112 may slide within a substantially longer shaft, such that the fingers 104 are actuated when the cammed actuator 112 passes said finger 104, and in a relaxed or neutral position before and after said cammed actuator 112 passes by. In various embodiments, the rack 108 may be affixed to a weight module or other heavy component and configured to translate said weight module along the plurality of fingers 104 as the fingers locomote the rack 108 along. In various embodiments, the plurality of fingers 104 may be affixed to the weight module, such that actuation of the fingers 104 translates the weight module and the fingers 104 along a stationary rack 108 disposed within the shaft, such as vertical mineshaft.

In various embodiments, rack 108 may be affixed to a weight module or heavy component that is acted upon by gravity. The force of gravity pulling the weight module downward through a vertical shaft, for example, The weight module with the rack 108 affixed thereto may travel downward through the shaft under the force of gravity, with the undulations of the rack configured to in turn press upon the heads of the plurality of fingers 104, the plurality of fingers 104 in turn being alternate pressed into a retracted state by the rack 108, which in turn forces the cammed actuator 112 to translate up or down in the shaft, which may in turn rotate a shaft or other mechanical device configured to generate electricity.

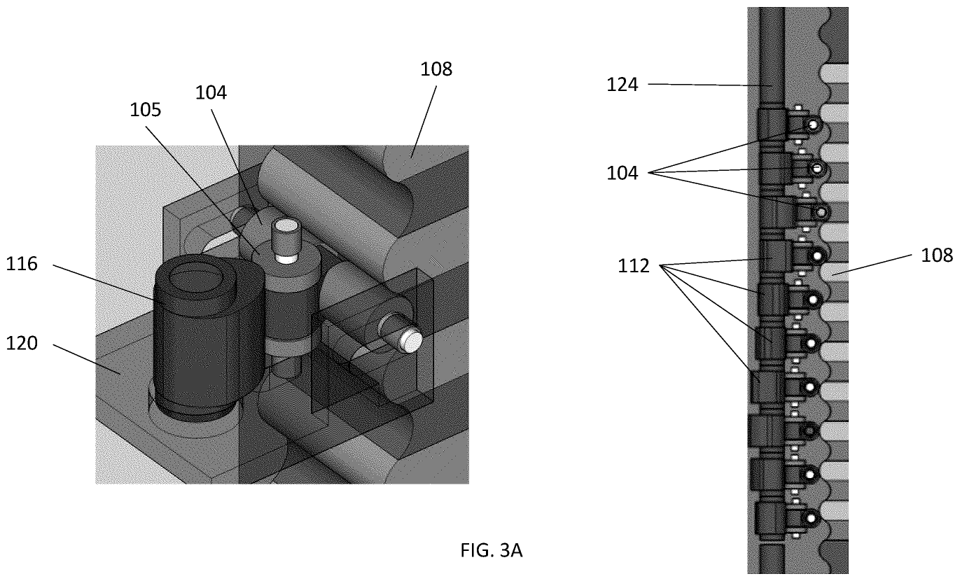

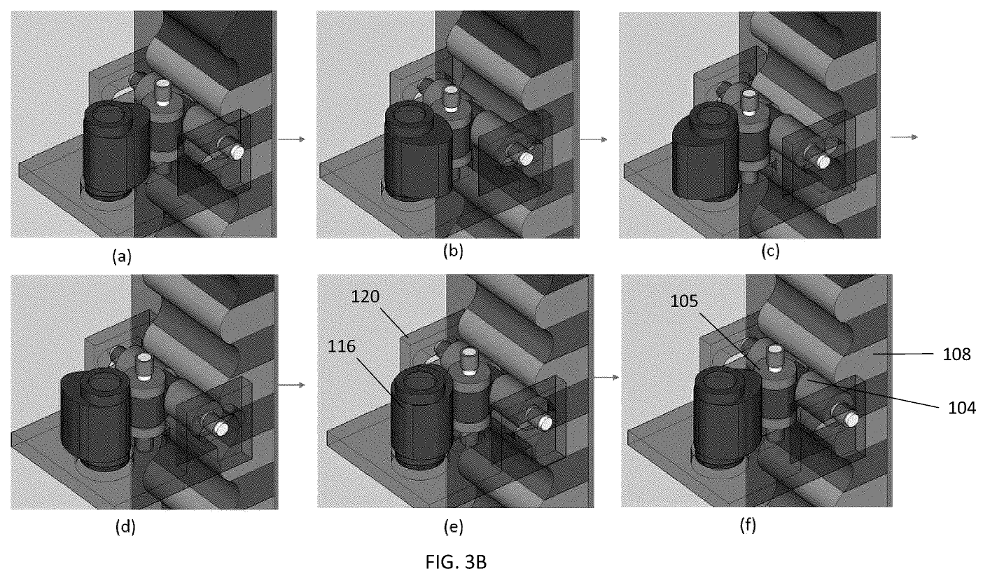

As shown in FIG. 3A-3B, an embodiment of LDCS 100 is shown in detail views. As described above, a rack 108 may have an undulating surface disposed proximate and facing a plurality of fingers 104. On the left hand side of the FIG. 3A, a single finger 104 is shown in detail view, one of skill in the art would appreciate the single finger 104 can be applied in an arbitrarily long train of fingers 104, with each finger's cam angularly offset from an immediately previous and successive cam. In various embodiments, finger 104 may be ride over the undulating surface of rack 108, shown in a valley in the particular depiction of FIG. 3A. Specifically a cam 116 may be rotatably coupled to the camshaft 124 and a follower 105 coupled to or integral to finger 104, which is contacting the rack 108. The cam 116 may be acted upon by the finger 104 and the follower 105, thereby rotating a camshaft 124 and further turning a rotor of electric motor and/or generator.

The finger 104 may be in physical communication with a cam 116. The finger 104 may be forced back by the force of the peak of rack 108 travelling over it, thereby forcing the cam 116 to rotate. Finger 104 may have bosses disposed on either side of a generally cylindrical head, each of the bosses disposed within the slots of a finger casing 120. Finger casing 120 may be a generally box-shaped component configured to constrain the relative perpendicular position of the finger 104 and the cam 116. The slots of finger casing 120 may be disposed horizontally, or perpendicularly to the axis of rotation of the cam 116, which may be disposed vertically or parallel to the longitudinal axis of the rack 108. In various embodiments, as the finger 104 is pushed backward towards cam 116, the cam's surface rides over the finger 104 and is force to rotate.

The rotation of cam 116 can be seen in FIG. 3B, which shows a detail view of a cam 116 rotatably coupled to the camshaft (not shown for clarity) and a follower 105 coupled to or in contact with a finger 104, which in turn is contacting the rack 108. The cam 116 can be rotated by an actuator coupled to the camshaft such as electric motor and/or generator. In various embodiments, the system can be run in reverse, where a weight module is affixed to the rack 108 and is allowed to pass through a vertical shaft. The wave pattern of the rack 108 may push on the finer 104 and move the follower 105, thus pushing the cams 116 and turning the cam shaft. This exemplary embodiment does not limit the output of the rotational energy of the system 100, and the actuator or device affixed to any portion thereof. The motor and generator may be the same component or two distinct components. There may be any number of motors and generator electrically and mechanically coupled to the system described herein. In reverse, the cam 116 rotates with the camshaft, pushing the follower 105 coupled to the finger 104 inward and outward along with the plurality of finger 104 above and below it to pass the rack 108 along its length. The cams 116 of subsequent fingers 104 may be radially offset from each other such as to create a wave pattern of the fingers 104 moving towards and away from the rack 108. The offset of the cams 116 may facilitate a continuous rotation depending on the location along the length of the rack.

As shown in the right-hand side of FIG. 3A, cam 116 may be disposed on or coupled to a camshaft 124. Camshaft 124 may be disposed through the vertical center of the cam 116. In various embodiments, camshaft 124 may be disposed at any orientation relative to the cam 116 surface such that an angular displacement of the cam imparts a certain rotation to the camshaft 120. In various embodiments, the camshaft 124 may be disposed perpendicularly to the cam 116 surface such that one full rotation of the cam 116 imparts a full rotation of camshaft 124. In various embodiments, camshaft 124 may be integral to cam 116 or any plurality of cams 116, as shown in the right-hand side of FIG. 3A. In various embodiments, camshaft 124 may be coupled to the plurality of cams 116 or a singular cam 116 by a press fit or by any type of mechanical fastener. In various embodiments, camshaft 124 may be adhered to cam 116 via one or more chemical adhesives. In various embodiments, camshaft 124 may include a concentric cut out which the cam 116 circumscribes and is retained by a substantially larger camshaft radius disposed on either planar surface of the cam 116.

As shown on the right-hand side of FIG. 3A, camshaft 124 may be coupled to a plurality of cams 116, each cam 116 having an angular displacement relative to an immediately preceding or succeeding cam 116, said angular offset can correspond to a longitudinal displacement, such that the cams 116 are disposed in angularly offset patterns. For example and without limitation, every cam 116 may be offset by 36 degrees from an immediately adjacent cam, such that every 11^{th} cam 116 is angular aligned. In various embodiments, each cam 116 can have any angular displacement relative to an adjacent cam or be disposed at the same angle. In various embodiments, the rack 108 may force the cams 116 in a wave pattern such that a subset of peaks of the rack 108 force cams 116 to rotate via interaction with the horizontally-displaced fingers 104. As the rack 108 moves over the plurality of fingers 104, the cams 116 may be configured to continually rotate, thereby imparting continuous rotation to the camshaft 124. In various embodiments, camshaft 124 may be rotatable coupled to one or more electricity-generating components such as an electric motor or generator. As the camshaft 124 rotates, the generator may generate electricity. The motor and generator may be the same component or two distinct components. There may be any number of motors and generator electrically and mechanically coupled to the system described herein. The cam 116 rotates with the camshaft 124, pushing the follower 105 and finger 104 inward and outward along with the plurality of fingers 104 above and below it to pass the rack 108 along its length. One of skill in the art would appreciate the system 100 may be oppositely controlled. For example and without limitation, the electric generator coupled to the camshaft 124 may exert a rotational force on the camshaft 124, thereby rotating the cams 116 and passing the rack 108 upward through the shaft. Alternatively or additionally, the rack 108 may move downwards under the force of gravity and force the cam 116 by contact with the finger 104, thereby turning the camshaft 124 and turning the rotor of the electric motor, thereby forming an electric generator. In various embodiments, the rack 108 may be acted upon by a force to move the wave pattern into contacting the fingers 104, the fingers thereby contacting the cams 116 and turning the camshaft 124, and in turn rotating the rotor of an electrical generator affixed thereto, thereby generating electricity, that may be stored therein or offsite, in various embodiments.

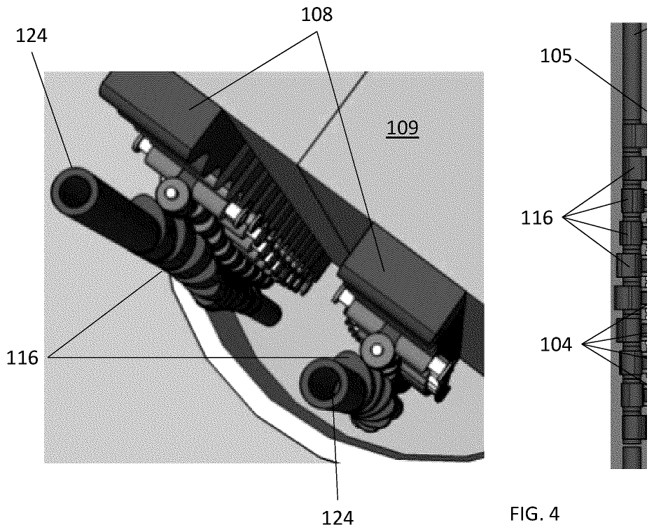

Referring now to FIG. 4, LDCS 100 is shown in elevation perspective view and orthogonal side view, on the left and right hand sides, respectively. LDCS 100 can include one or more racks 108 with associated plurality of fingers 104 coupled to a camshaft 124. As shown in the left-hand side of FIG. 4, a generally rectilinear weight module 109 may be affixed to any number of racks 108. In various embodiments, the weight module 109 may be affixed to two racks 108. In various embodiments, weight module 109 may be affixed to four racks 108, with two racks 108 disposed on opposite lateral sides of the rectangular prism-shaped weight module 109. Each camshaft 124 may include cams having equal angular displacement to any other camshaft 124 disposed in the system, as can be seen in left-hand side of FIG. 4. The translation of the weight module 109 down the shaft may rotate the camshafts 124 an equal angular rotation per vertical travel, such that each camshaft is rotating at the same angular velocity. In various embodiments, the cam rotations may be unique to each camshaft such that vertical movement of the weight module 109 rotates the camshafts 124 at varying rotational velocities.

With continued reference to FIG. 4, the right-hand side system 100 shows two camshafts 124 disposed on either side of weight module 109, each side of weight module 109 coupled to a rack 108. Each camshaft 124 may include a similar cam 116 distribution, such that horizontally-aligned cams 116 contact the racks 108 at the same depth within the racks 108. As can be seen in the right-hand side of FIG. 4, the topmost fingers 104 are disposed within the valleys of the racks 108, and the centermost finger 104 on either side is contacting the peak of the racks 108. This train of cams 116 can be arbitrarily long such that any number of fingers 104 can contact the rack 108 and cams 116 along the vertical position of the weight module 109.

Specifically, as shown in FIG. 4, cams 116 can be seen at varying positions during a snapshot in time, thus creating a varied contact profile of the plurality of fingers 104 with the rack 108. It should be noted that the weight module 109 and rack 108 can be acted upon by gravity to force the wave pattern of its undulating surface into contacting the plurality of fingers 104, the fingers 104 in turn forcing rotation of the cams 116, turning the camshaft 124, and in turn rotating the rotor of an electrical generator affixed thereto thereby generating electricity.

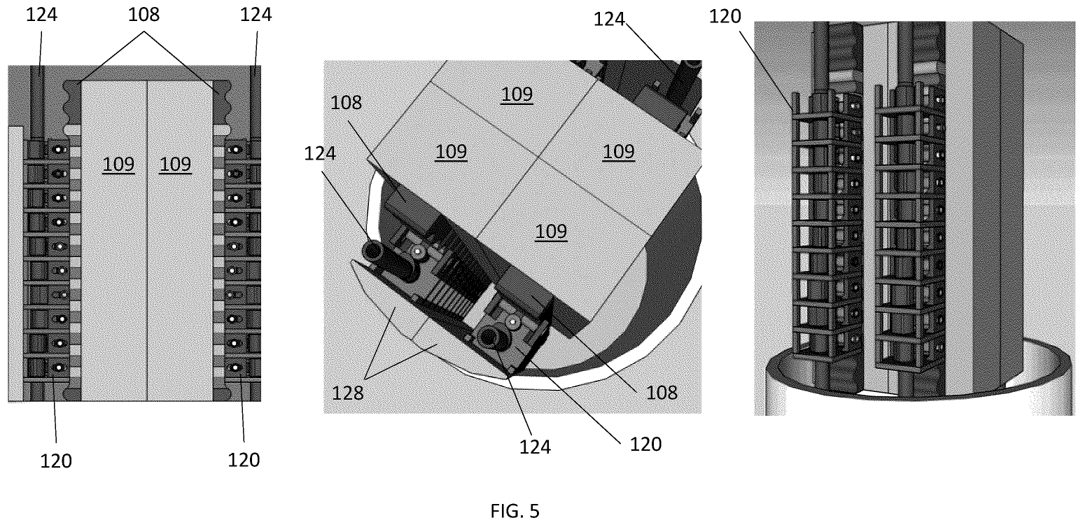

Referring now specifically to FIG. 5, system 100 utilizing four camshafts 124 is shown orthogonally (left-hand side) and isometrically from above (middle) and perspective side view (right-hand side). In various embodiments, as shown, the camshafts 124 can sunk into a load-bearing component 128 affixed to the side of the shaft such that the cams 116 do not impart the load of the weight module 109 onto the camshafts 124 themselves, thus preventing damage and warping over time, which can cause critical failures and rupture of the camshafts 124. In various embodiments, each cam 116 can be partitioned from the adjacent cams 116 by cam casing 120. Cam casing 120 may be individual casings disposed around each cam 116 and coupled to adjacent cam casings to form a longitudinal column of cam casings. One of ordinary skill in the art would appreciate that the cam casings may be formed integrally or additively manufactured, and this exemplary embodiment or any described herein do not limit the arrangement of relative cams to each other within cam casing 120. In various embodiments, the weight module 109 may be forced downward due to gravity, thus forcing the four racks 108 against the four plurality of fingers 104, thereby forcing the four camshafts 124 coupled thereto to rotate. In various embodiments, each camshaft 124 may be coupled to a distinct electric generator. In various embodiments, each of the four camshafts 124 may be coupled to a common transmission or other gearbox configured to transmit the rotation of the four camshafts to a single rotor shaft of an electric generator. In various embodiments, a portion of the camshafts 124 may be coupled to a first electric generator and a second portion of the camshafts 124 may be coupled to a second electric generator. In various embodiments, the weight module 109, which is affixed to the racks 108, may be acted upon by gravity to force the wave pattern into contacting the plurality of fingers 104, the fingers 104 thereby contacting the cams 116 and turning the camshafts 124 at the same rotational velocity. In various embodiments, each camshaft 124 may be forced to rotate at a distinct rotational velocity as a result of varying cam profiles or angular offset of the plurality of cams coupled thereto.

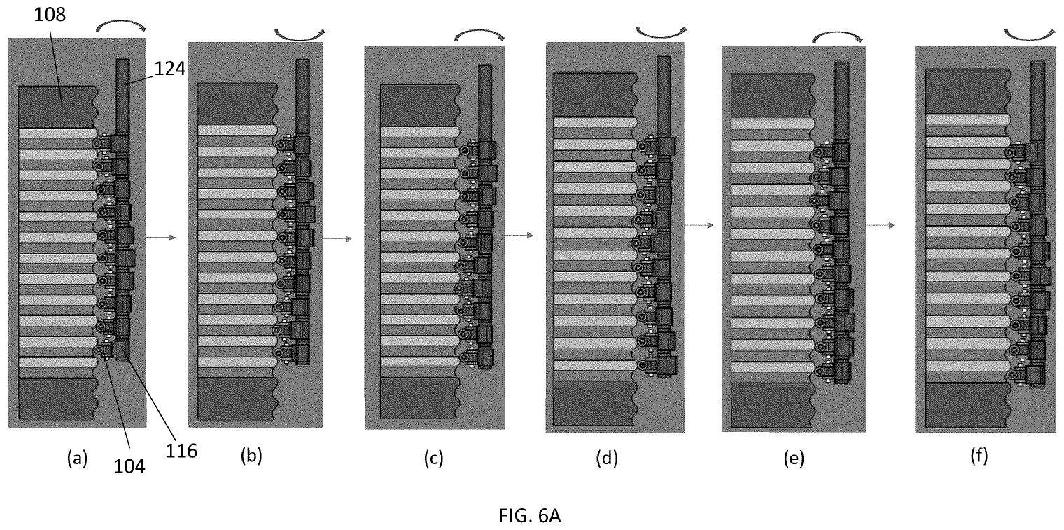

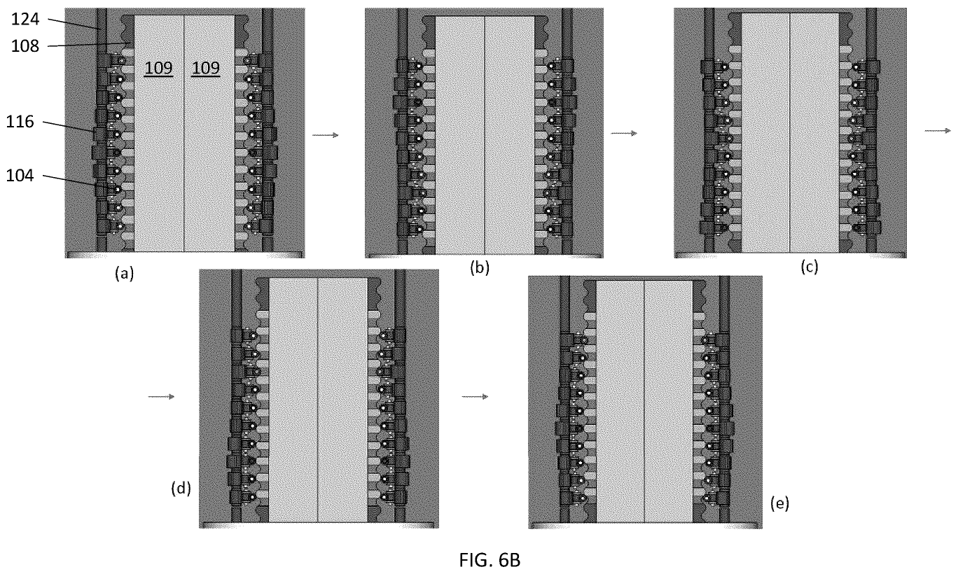

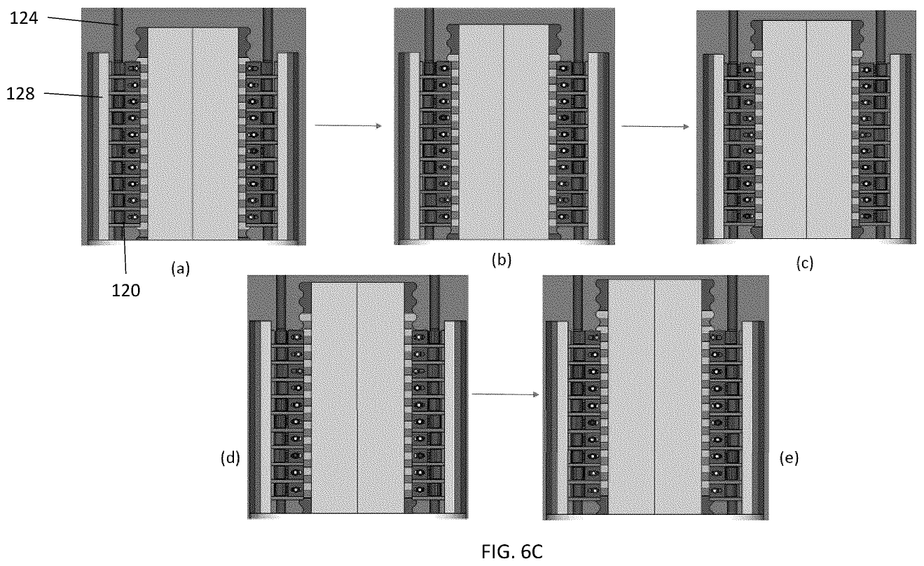

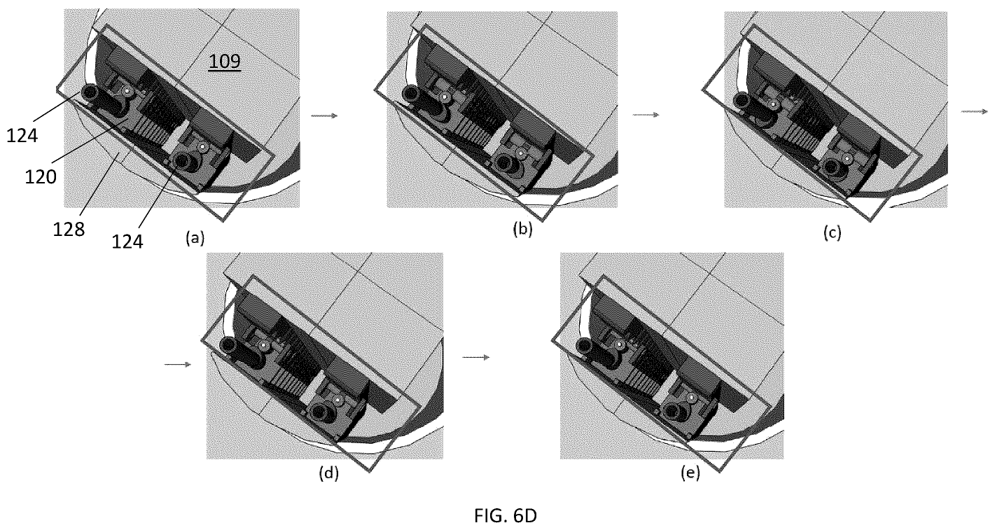

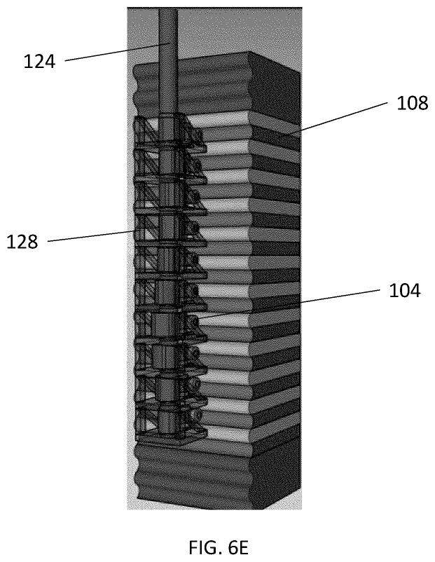

Referring now to FIGS. 6A-6E, system 100 is depicted in several snap shots in time over the rotation of at least one camshaft in response to the movement of at least one rack. Steps (a)-(f) in FIG. 6A show the undulation of the plurality of fingers 104 relative to the relative position of rack 108. As can be seen at (a), the topmost finger 104 is disposed in a valley of the rack 108 undulations. As the rack moves relative to the fingers 104, in this case, upwards, the fingers 104 are depressed toward the camshaft 124. The cams 116 can be seen rotating in response to the movement of the fingers 104, thereby turning camshaft 124, the rotation of camshaft 124 is shown by the illustrative arrow depicted above. In the one-sided embodiment depicted in FIG. 6A, a full rotation of the camshaft is depicted, wherein the topmost finger 104 is shown in (f) being disposed in the adjacent valley of the rack 108 from which it started. This motion can be extended for any arbitrary length of rack 108, plurality of fingers 104, camshaft 124 or the like. In various embodiments, FIG. 6A (a-f) may depict the cam shaft turning 124 under the power of an external power source, such as an electric motor, thereby moving the fingers 104 inward and/or outward laterally in a wave pattern, thus passing the rack 108 and a weight module affixed thereto (not shown). In various embodiments, this system can transfer energy in an opposite chain reaction, where the rack 108 (and weight module affixed thereto) can be acted upon by gravity to force its wave pattern into contacting the plurality of fingers 104 in a successive manner, the plurality of fingers 104 thereby contacting the cams 116 via the followers 105 and turning the camshaft 124. The camshaft 124 can then rotate the rotor of an electrical generator affixed thereto, thereby generating electricity.

As shown in FIG. 6B, a two-sided embodiments of system 100 is shown in a series of snapshots over the rotation of the camshafts 124 disposed on either side of weight modules 109. In various embodiments, weight modules 109 may be disparate weight modules coupled together or a single continuous weight module 109. Steps (a-e) in FIG. 6B show the undulation of the plurality of fingers 104 relative to the relative position of rack 108. As can be seen at (a), the topmost fingers 104 are disposed in respective valleys of the racks 108 undulations. As the racks moves relative to the fingers 104, in this case, upwards, the fingers 104 are depressed outward towards the camshafts 124. The cams 116 can be seen rotating in response to the movement of the fingers 104, thereby turning camshafts 124, the rotation of camshafts 124 is shown by the illustrative arrow depicted above. In the two-sided embodiment depicted in FIG. 6B, a full rotation of the camshafts is depicted, wherein the topmost fingers 104 is shown in (e) being disposed in the immediately adjacent and below valleys of the racks 108 from which they started. This motion can be extended for any arbitrary length of racks 108, plurality of fingers 104, camshafts 124, weight modules 109 or the like. In various embodiments, FIG. 6B (a-e) may depict the camshafts 124 turning under the power of one or more external power sources, such as one or more electric motors, thereby moving the fingers 104 inward and outward laterally in a wave pattern, thus passing the racks 108 and the weight modules 109 upward. In various embodiments, this system can transfer energy in an opposite chain, where the racks 108 and weight modules 109 can be acted upon by gravity to force its wave pattern into contacting the plurality of fingers 104 in a successive manner as it travels downward, the plurality of fingers 104 thereby successively contacting the cams 116 via the followers 105 and turning the camshafts 124. The camshafts 124 can then rotate the rotor of one or more electric generators affixed to the camshaft, thereby generating electricity. In various embodiments, each camshaft 124 can be coupled to the same electric motor directly or via one or more gearboxes or transmissions.

As shown in FIGS. 6C-6D, substantially the same double-sided embodiment of system 100 shown in FIG. 6B, is shown in orthogonal side view over a series of snapshots of the camshaft 124 rotations and vertical position of the weight modules 109. FIG. 6C depicts the load bearing element 128 affixed to plurality of cam casings 120 in a two-sided embodiment and FIG. 6E depicts load bearing element 128 in a single-sided embodiment. Load bearing elements 128 may be affixed to each cam casing 120. In various embodiments, load bearing elements 128 may be coupled to a portion of cam casings 120. In non-limiting embodiments, load bearing elements 128 may be coupled to every other cam casing 120 or another subset of cam casings 120 disposed on that side of weight module 109. Load bearing elements 128 may be coupled to the sides or cylindrical sidewall of a vertical shaft. In various embodiments, load bearing elements 128 may be coupled to bedrock underground, wherein the shaft is disposed at least partially underground. In various embodiments, load bearing elements 128 may be bolted to the bedrock or via one or more other mechanical fasteners. In various embodiments, load bearing elements 128 may be affixed to the bedrock using one or more mechanical anchors or other components configured to arrest the motion of load bearing element 128 to the vertical shaft. The load bearing elements 128 may be any suitable bearing or structure that connects the system 100 to a subsurface geological feature such as bedrock, and allow the camshaft 124 to turn within it without transferring the load of the weight module 109 to the camshaft 124 itself. The load bearing element 128 may be formed from cast, forged or otherwise shaped steel. The load bearing element 128 may be formed from welded steel beams, such as I-beams or structural steel. The load bearing element 128 may have a continuous or semi-continuous opening for the camshaft to rotate within. As seen in FIGS. 6C-6E, each cam 116 may be disposed in a separate section of the load bearing element 128. In various embodiments, the cams 116 can be open to each other and not partitioned within load bearing element 128. In various embodiments, load bearing elements 128 may be a series of straight segments joined together to form a structure spanning the length of the plurality of fingers 104. In various embodiments only a portion of the plurality of fingers 104 are supported by the load bearing element 128. In various embodiments, the entirety of the plurality of fingers 104 can be supported by the load bearing element(s).

FIG. 6C-6D shows a series of steps in the locomotion process of the camshafts and cam (boxed in red) at varying stages of rotation. The camshafts can each be seen as rotatably affixed to the load bearing element, the load bearing element affixed in turn to the side of the shaft (or tunnel, depending on arrangement of the LDCS). Additionally, steps (a-e) in FIGS. 6C-D show the undulation of the plurality of fingers 104 relative to the relative position of rack 108 within cam casings 120. As can be seen at (a), the topmost fingers 104 are disposed in respective valleys of the racks 108 undulations. As the racks moves relative to the fingers 104, in this case, upwards, the fingers 104 are depressed outward towards the camshafts 124. The cams 116 can be seen rotating in response to the movement of the fingers 104, thereby turning camshafts 124, the rotation of camshafts 124 is shown by the illustrative arrow depicted above. In the two-sided embodiment depicted in FIG. 6B, a full rotation of the camshafts is depicted, wherein the topmost fingers 104 is shown in (e) being disposed in the immediately adjacent and below valleys of the racks 108 from which they started. This motion can be extended for any arbitrary length of racks 108, plurality of fingers 104, camshafts 124, weight modules 109 or the like. In various embodiments, FIG. 6B (a-e) may depict the camshafts 124 turning under the power of one or more external power sources, such as one or more electric motors, thereby moving the fingers 104 inward and outward laterally in a wave pattern, thus passing the racks 108 and the weight modules 109 upward. In various embodiments, this system can transfer energy in an opposite chain, where the racks 108 and weight modules 109 can be acted upon by gravity to force its wave pattern into contacting the plurality of fingers 104 in a successive manner as it travels downward, the plurality of fingers 104 thereby successively contacting the cams 116 via the followers 105 and turning the camshafts 124. The camshafts 124 can then rotate the rotor of one or more electric generators affixed to the camshaft, thereby generating electricity. In various embodiments, each camshaft 124 can be coupled to the same electric motor directly or via one or more gearboxes or transmissions.

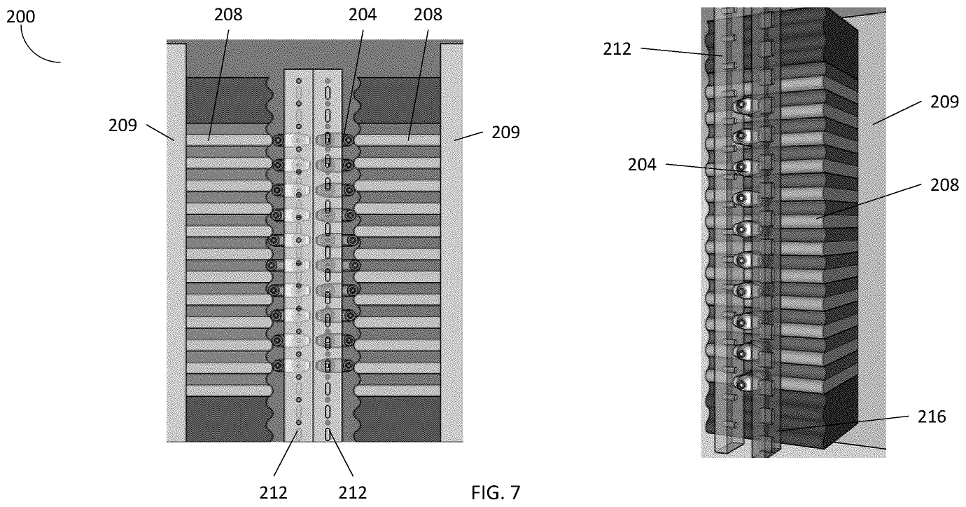

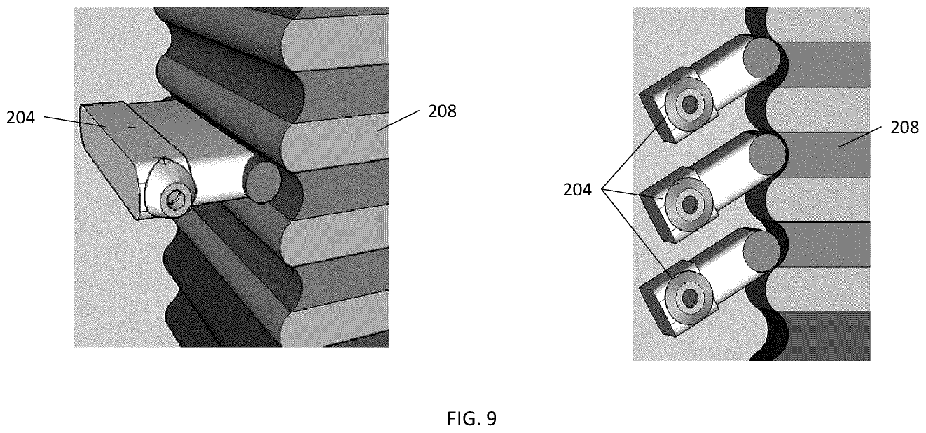

Referring now to FIGS. 7-9 are schematic representations of a linear conveyance system 200 in accordance with the disclosed subject matter. LDCS 200 may include a plurality of fingers 204. Fingers 204 may be constructed similarly to fingers 104, having a cylindrical head having a curvilinear contact surface coupled to a stem extending from the curvilinear surface perpendicular to the cylindrical axis. In various embodiments, plurality of fingers 204 may be configured to actuate in response to an input. In various embodiments, plurality of fingers 204 may be configured to extend and retract relative to another component. In various embodiments, plurality of fingers 204 may be configured to telescope along an extendable stem. In various embodiments, fingers 204 may be configured to tilt or rotate relative to a pivot axis. In various embodiments, fingers 204 may pivot about an axis parallel to the cylindrical head's axis, disposed opposite the finger form the cylindrical head, as shown in FIG. 9. Plurality of fingers 204 may be configured as described in reference to system 100.

In various embodiments, system 200 may include at least one rack 208. In various embodiments, rack 208 may be a generally rectilinear component with at least one surface having an undulating or wave like surface having a plurality of alternating peaks and valleys forming a continuous wave. The wavelike surface of the rack 208 may be disposed opposite and opposing the fingers 204, the plurality of fingers oriented toward the wavelike surface of rack 208 such that the cylindrical heads are disposed proximate the peaks and valleys of rack 208 within an actuatable range of fingers 204. In various embodiments, rack 208 may be disposed proximate the fingers 204 such that when the fingers 204 actuate towards the rack 208, the fingers 204 can contact the rack 208 within a valley or on a peak of the wavelike surface. In various embodiments, as described above, each finger 204 may be alternately or successively actuated in order to pass the rack 208 along the plurality of fingers 204. Alternatively or additionally, the plurality of fingers may be actuated in succession by coming into contact with the rack 208 translating relative to the plurality of fingers, for example, as the rack 208 is acted upon by gravity and moves downward. In various embodiments, the plurality of fingers 204 may be commonly coupled to an actuator or coupled to a distinct actuator.

In various embodiments, each finger of the plurality of fingers 204 may be in fluid communication to a hydraulic manifold 212, 216. In various embodiments, each finger 204 of a plurality of fingers 204 may be in fluid communication with one or more hydraulic lines, the hydraulic lines feeding oil to said fingers 204, which may be include an embedded piston having a cylinder and plunger. In various embodiments, the hydraulic manifold 212, 216 may be configured to extend or retract the fingers 204. In various embodiments, hydraulic manifold 212 may be an input manifold and hydraulic manifold 216 may be an output manifold. In various embodiments, hydraulic oil may be pumped into hydraulic manifold 212 and further into the plurality of fingers 204. In various embodiments, hydraulic oil may be configured to actuate the fingers 204 in linear or angular range of motion. For example and without limitation, fingers 204 may be configured to extend or retract perpendicular to the surface of rack 108. In various embodiments, plurality of fingers 204 may be configured to actuate in an angular range in response to the hydraulic oil. In various embodiments, hydraulic oil may enter a piston disposed underneath or adjacent to each finger 204, the extending piston configured to angle the finger 204. Alternatively, the hydraulic oil exiting the piston disposed adjacent to each finger 204, retracting the finger 204, thereby angling said finger 204 in an opposite angular deflection.

In various embodiments, the plurality of fingers 204 may each be connected to a hydraulic line disposed within hydraulic manifold 212. In various embodiments, only a portion of fingers 204 are connected to one more hydraulic lines. In various embodiments at least a portion of the fingers 204 are connected to a hydraulic manifold. In various embodiments, at least a portion of the fingers 204 are hydraulically connected to one another. In various embodiments, each of the fingers 204 is hydraulically connected to one another. In various embodiments, the hydraulic pump is configured to selectively provide oil to each of the plurality of fingers 204. In various embodiments, one or more computing systems such as a controller are used to manage the dispersion of oil within the system.

In various embodiments, the rack 208 pushing against the fingers 204 deflect pistons down due to gravity or another force may cause the oil to move through the lines or manifold and turn or move another component, thereby generating electricity or another type of energy. In various embodiments, rack 208 may be affixed to a weight module 209 as described herein above. In various embodiments, at least a portion of the fingers 204 (and therefore pistons) may be angled upward (in a vertical arrangement as shown in FIG. 9). In various embodiments, the pistons may be normal to the shaft. In various embodiments, the plurality of fingers 204 may be disposed at an angle compared to the pistons. In various embodiments, the pistons may be adjustable such to change their angle individually or collectively.

In various embodiments, any of the system described herein may utilize a hydraulic piston drive and hydraulic drive locking default mechanism. For example and without limitation, a series or wheel of pistons may be radially disposed about an axis and configured to rotate within a scalloped ring or within the hydraulic manifolds. The actuation of the pistons in an out within the scallops or valleys of the rack may cause relative rotation of the inner and outer rings, or the inverse, wherein a rotation of the rings, causes the actuation in and out of biased pistons. In various embodiments, the springs in each piston are used to disengage into a freewheel. In various embodiments, the pistons may be configured with the inverse arrangement, wherein the springs are configured to bias the pistons outward in the extended position, thus actuating the pistons downward when the outer ring moves across the piston head. In various embodiments, one or more pistons may be locked to arrest relative motion of the rings.

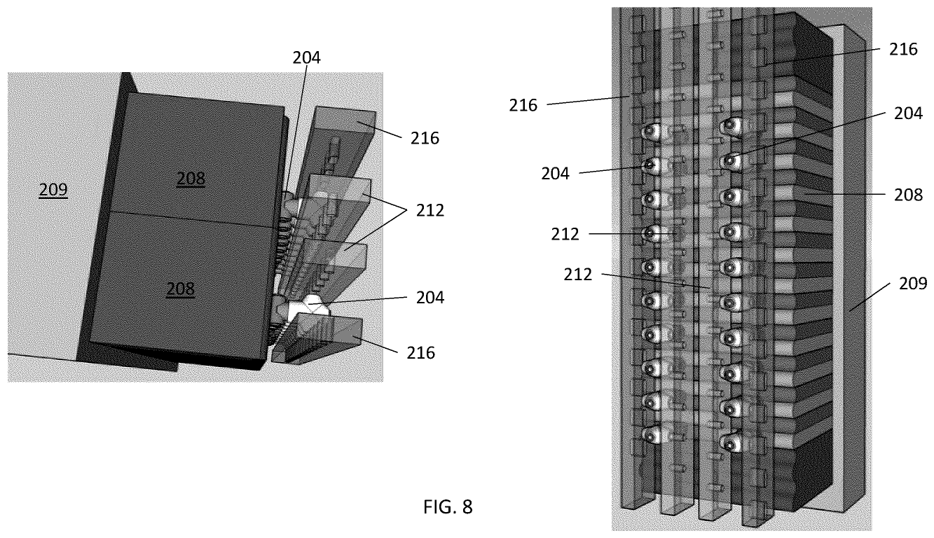

Now referring specifically to FIG. 8, the LDCS 200 is shown from a top isometric view (left) and a side isometric view (right). There are two pluralities of fingers 204 shown. Each plurality having an “in” and “out” channel in fluid communication with hydraulic manifolds 212, 216, respectively. The common “in” channels are disposed next to each other between the pluralities of fingers 204 within hydraulic manifold 212. The “out” channels disposed outside of each plurality of fingers 204 and spaced from each other within hydraulic manifold 216. The in and out hydraulic lines, channels or hoses may be connected in a loop or to a common source or recirculation system. There may be one or more hydraulic pumps in fluid communication with each of the in and out channels, configured to push or pull oil from the system. The oil traveling through the in channel may push out the effectors in a wave pattern, the used oil escaping the system through the out channels and back to the pump or hydraulic motor disposed above or below the system. In various embodiments, the ‘in’ hydraulic manifold 212 may be disposed inward of the plurality of fingers and the ‘out’ hydraulic manifold 216 may be disposed outward of the plurality of fingers 204. In various embodiments, rack 208 may include more than one plurality of fingers 204 disposed parallel to each other. Each plurality of fingers 204 may include a distinct ‘in’ hydraulic manifold 212 and ‘out’ hydraulic manifold 216. In various embodiments, each ‘in’ hydraulic manifold 212 may be disposed inward of both sets of fingers 204 and each ‘out’ hydraulic manifold 216 may be disposed outward of fingers 204, as shown in FIG. 8. The interaction of hydraulic oil within the channels may control the timing of the pistons and effectors along the length of the LDCS. The channel's input holes may be positioned to engage/disengage with relative timing to create the wave pattern of the effectors. In various embodiments, an array of pistons where each piston's drive position is offset so as to match the similar wave formation may be utilized. There may be extra or interstitial pistons that would be in intermediate positions between the extremes. The pistons may be each attached to a pivot mount which is secured to the wall (bedrock) to enable the bulk of the load to be transmitted to the wall (bedrock). An actuator rod or a loop of cable may be strung along the pivot mounts so as to be able to rotate the pivot mounts or somehow exert a leverage force on each of the pistons. A loop of cable would allow for forces in both directions by pulling on one side or the other. The actuator is cycled up and down in a harmonic pattern which in turn cycles the pistons in a harmonic manner. A motor may be connected at the end of the actuator in such a way that its rotation is synchronized to the harmonic linear motion of the actuator.

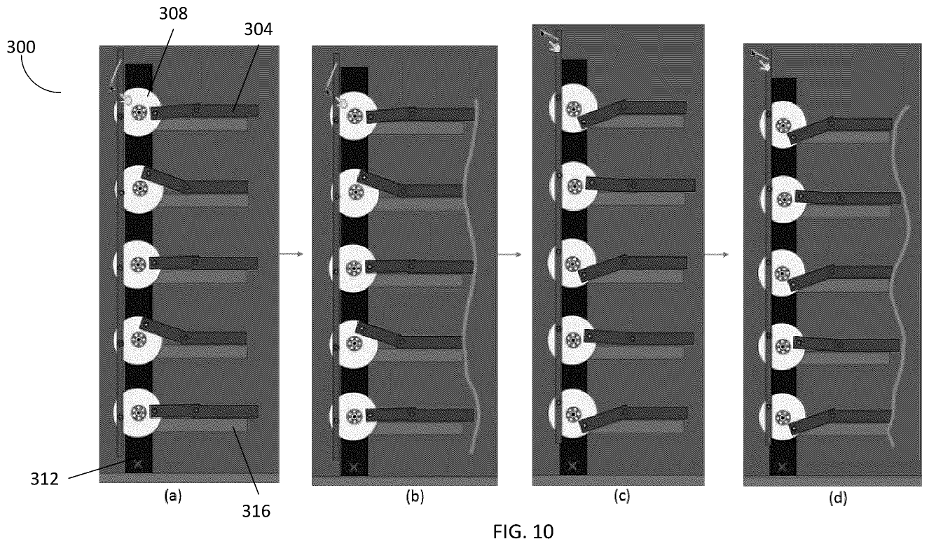

Referring now to FIG. 10, a schematic representation of a linear drive conveyance system (LDCS) 300 in accordance with the disclosed subject matter is shown in a series of side views (a) through (d). Each of the fingers 304 is shown as a linkage affixed to a wheel 308, each of the wheels commonly connected to a vertical bar 312 (in this view, although this does not limit the relative orientation of the system). With the turning of the wheels 308, each of the fingers 304 are actuated outward and rightward at varying degrees, depending on the attachment point of the wheel 308. The varied attachment point of the plurality of fingers 304 to the successive wheels 308 may form a wave like pattern of actuation of the fingers 304, thus providing the ability of the fingers 304 to locomote the rack (not shown) up or down along the length of the system 300. Each of the fingers 304 linkages are individually supported by a platform 316, but this is merely an example, as any suitable support for fingers 304 may be employed. Each of the supports 316 may be affixed together in an arrangement similar to or the same as the load bearing element discussed above. The load bearing element or platforms 316 may transfer the weight module of the rack (and anything attached thereto, such as a weight module) to bedrock disposed in an underground shaft and not to the fingers 304 linkages themselves, which require freedom of movement.

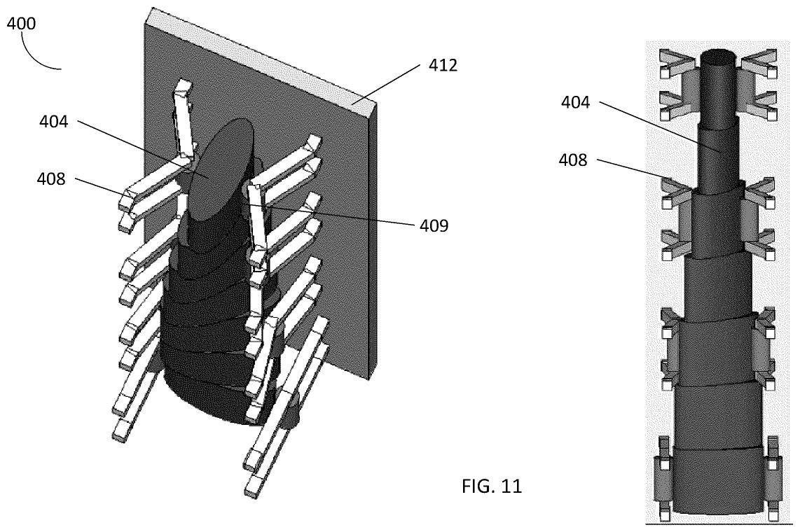

Referring now to FIG. 11, a schematic representation of a linear conveyance system 400 utilizing cams 404 and a plurality of linkages 408 in accordance with the disclosed subject matter is shown. Similar to system 100 shown above, system 400 utilizes a series of cams 404 having an offset profile commonly affixed to a camshaft (not shown) to move the plurality of linkages 408 inward and outward, thus extending the ends of the linkages 408 away from load bearing element 412, in turn locomoting the rack up or down along the length of the system 400. The cam 404 at the uppermost section of the left hand view is relatively perpendicular to the load bearing element 412, the followers 409 of the linkage 408 thereby moving close together and in turn retracting the linkage 404 away from the rack (disposed down and to the left), allowing other linkages 404 to move said rack. The right hand view reinforces this notion, as the topmost cams 408 are relatively thin, allowing for an angled linkage 408, as opposed to the bottom most cam 404, which produces an extended linkage 408. The linkages 408 thereby form a wave pattern informed by the relatively alignment and spacing of the cams 404, undulating and moving the rack affixed to one or more weight modules, along the train of linkages 408. In various embodiments, and conversely, the weight module of the rack may force the linkages 408 in and out, thus turning the cams 404 and thereby rotating a camshaft, the camshaft in turn moving a rotor of an electrical generator. In various embodiments, the camshaft may turn another component or transfer the torque into another form of usable or storable energy.

One of skill in the art would appreciate the plurality of components that may be used within a linear drive conveyance system, such as a ball screw, lead screw, screw jack, or the components describe herein above, among others. In various embodiments, the cam and follower arrangement as described herein does not experience sliding friction, only rolling friction, due to the type of effectors and shape of the rack, among other considerations.

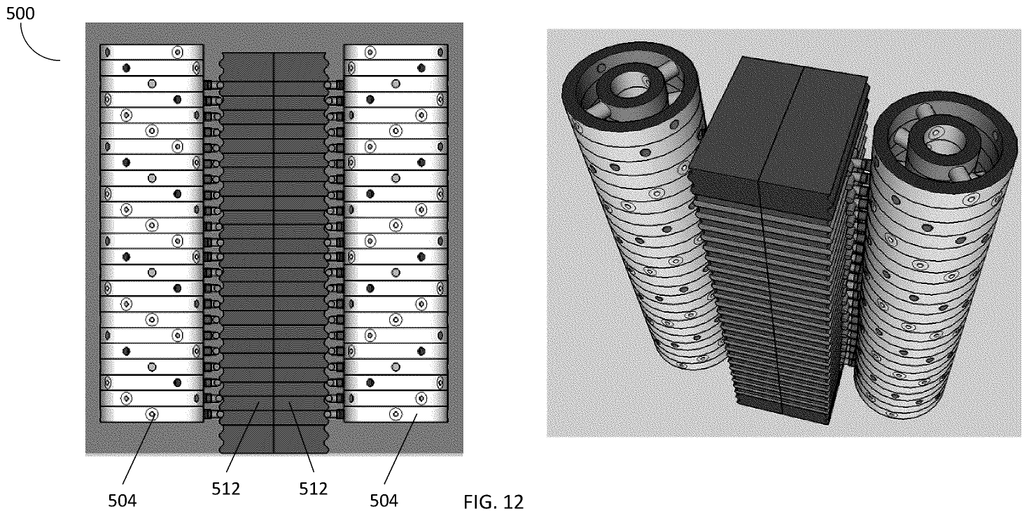

Referring to FIG. 12, an embodiment of the LDCS 500 is shown. This LDCS 500 utilizes turning components 504 that contact a plurality of fingers 508 and actuate said fingers 508 based on rotational position of turning components 504. In various embodiments, the fingers 504 may extend and retract inward and outward relative to racks 512, each having an undulating wave surface as described above disposed opposite and facing the plurality of fingers 508. In various embodiments, the turning components may actuate the plurality of fingers 508 based on rotational position of the turning components 504. In various embodiments, turning components may alter the distance and direction of actuation of the fingers 508 as a function of the rotational position, the rotating components 504 configured to impart a force, signal, fluid, or other method of extending and retracting the fingers 508 based on the rotation of the components. In various embodiments, variable connection or contact is made with the finger 508, for example a piston of the finger 508, the connection occurring only when a certain radially location of the rotating component 504 contacts the finger 508, thereby initiating the extension or retraction of that finger 508. The rotation of the rotating component 504 may be offset such that the plurality of fingers 508 extend in a wave pattern, as can be seen by the plurality of dots on the rotating components 504, those dots representing a connection point or signal generation point configured to extend the fingers 508 a certain distance and direction. In various embodiments, the dots may represent electrical connections that send a signal to a servo motor or other linear actuator configured to extend the finger 508 upon connection with said connection point with rotating component 504. In various embodiments the system may operate in reverse as described above with respect to systems 100-400, wherein the weight module of rack 512 moves the plurality of fingers, which are disposed at varying distances relative to the rack 512, thus turning the rotating components 504 and storing electrical energy in any suitable method described herein or otherwise known.

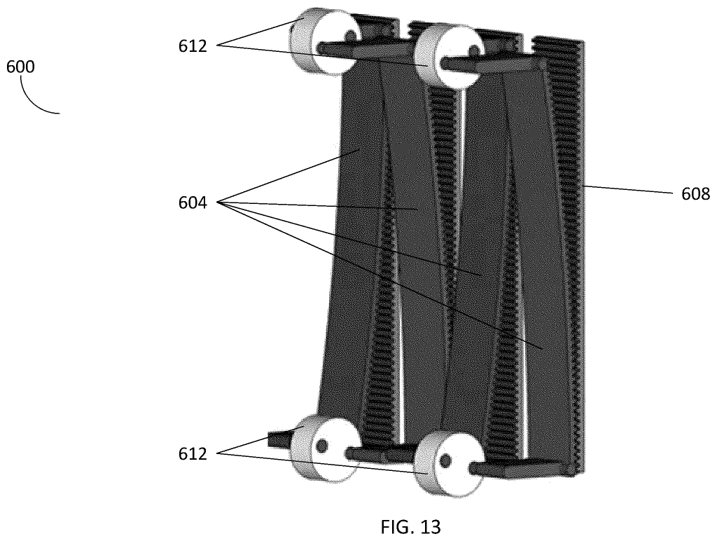

Now referring to FIG. 13, a schematic representation of a linear drive conveyance system 600 utilizing a rocking motion in accordance with the disclosed subject matter is shown in isometric view. The rocking section 604 LDCS 600 may have teeth that are configured to mesh with teeth of a rack 608. The rocking section 604 may include two toothed rockers that are rotatably coupled at each of their respective ends at varying points on wheels 612 and angled relative to each other. The rotation of the offset couplings generates a rocking motion in the rocking section 604, akin to a foot stepping down, the teeth of the engaging rocker 604 meshing with the teeth of the rack 608, the other rocker now rocking up and forward, meshing with said rack, the first rocker now disengaging with the rack and rotating up and forward. This rocking motion goes on as the rockers climb or descend the rack 608. One of skill in the art would appreciate that rockers of the rocking section 604 may move up or down the rack 608 or along the rack 608 if horizontal in either direction. Conversely, if the rockers of the rocking section 604 are allowed to be acted upon by gravity, the rotation of the coupling wheels 612 would be induced by the rockers falling down and towards the rack, engaging the teeth and rocking back and forth.

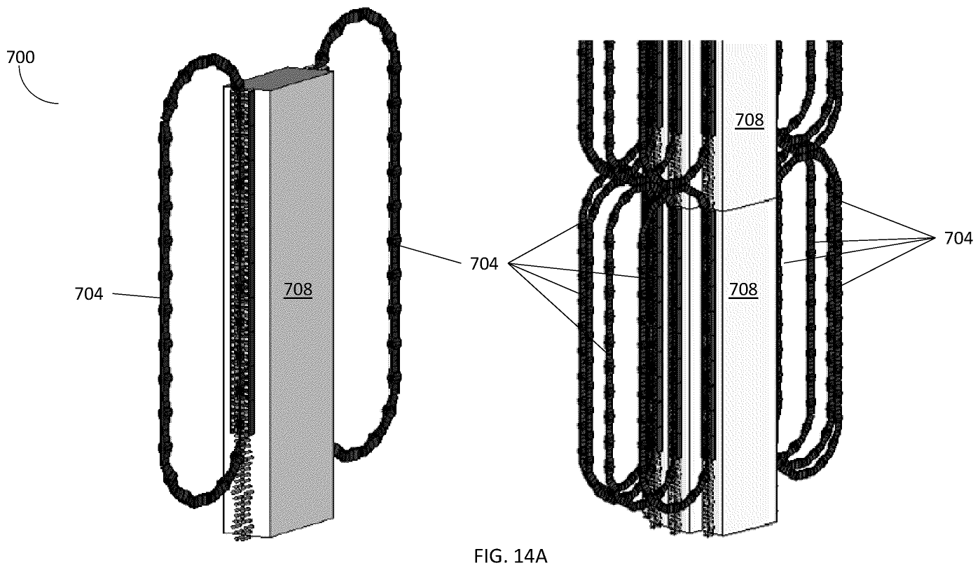

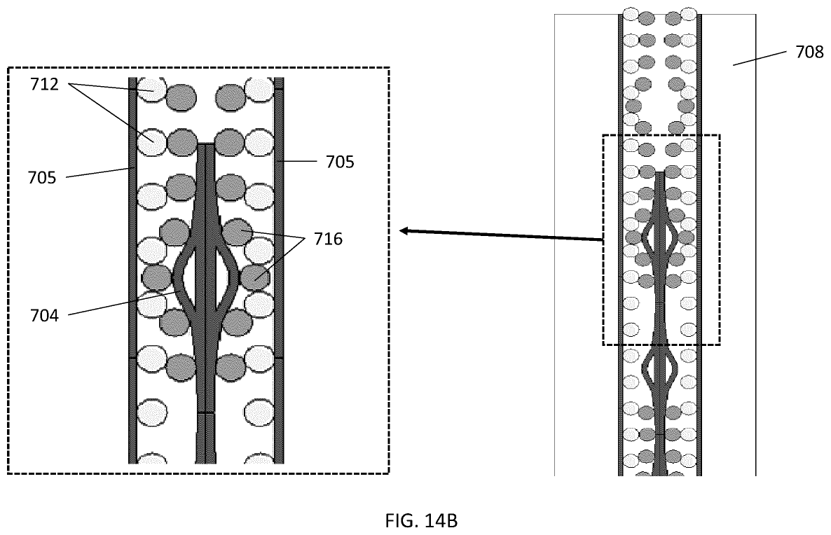

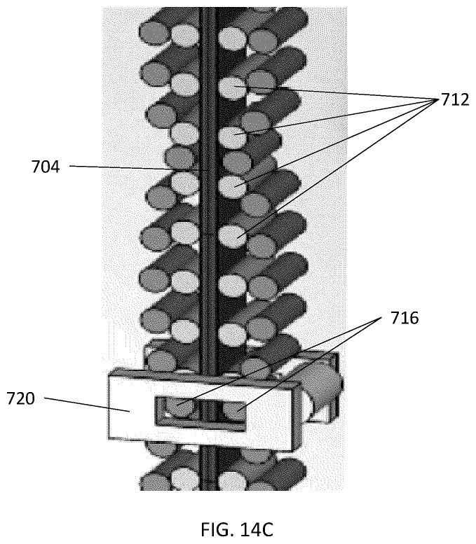

Referring now to FIG. 14A-14C, an exemplary embodiment of an LDCS 700 is shown in isometric and orthogonal views. In various embodiments, LDCS 700 may utilize a series of bearings to affect locomotion of one or more racks along a length of relatively stationary bearings. In various embodiments, any bearing described herein may be generally cylindrical roller bearing having cylindrical axis extending along the longitudinal length therethrough. In various embodiments, the cylindrical bearings may have generally flat circular ends disposed at either terminus of the bearings. In various embodiments, each bearing may have concentrically disposed pins extending from the circular termini configured to mate and reciprocate within generally oblong slots, as shown in FIG. 14C.

In various embodiments, LDCS 700 may include a belt 704. Belt 704 may a flat continuous loop, having a first and a second parallel sides, defining a first thickness therebetween. Belt 704 may have periodic bulges disposed along its continuous length. For example and without limitation, bulges may be opposite bulges that increase the thickness of the belt 704 over a certain run length of the belt. In various embodiments, the bulges may form an oblong or circular boss on either side of the belt 704. In various embodiments, the bulges may have a diamond shape profile, coming to two opposite and opposing peaks extending away from the center line of the belt 704. In various embodiments, the bulges may have any profile as desired. For example and without limitation, the bulges may have a generally trapezoidal shape extending from each side of belt 704, each trapezoidal side having flat peaks that rejoin the first thickness of the belt in opposite and opposing slopes preceding and succeeding the bulge peak. In various embodiments, belt 704 may be formed from a natural or synthetic rubber. In various embodiments, belt 704 may be formed from one or more composite materials, such as Kevlar® or another fiber based composite. In various embodiments, the belt 704 may be selectively or directionally rigid, configured to bend in a first direction and remain stiff in a second direction. In various embodiments, the belt 704 may be configured to vend in a lateral direction to form a continuous loop, as shown in FIG. 14A. in various embodiments, belt 704 may resist bending in a direction perpendicular to the central axis of the loop, thereby constraining the belt to a generally planar configuration. In various embodiments, the belt 704 may be rotatably or continuously coupled to one or more electricity-generating components, such as an electric motor, a generator, or a combination thereof. In various embodiments, the belt 704 may be formed from one or more metals or metal alloys, such as steels. In various embodiments, the belt 704 may be formed from a composite of a metal and non-metal. In various embodiments, the belt 704 may be configured to rotate while constrained to the plane of the loop shape shown in FIG. 14A.

LDCS 700 may include a weight module 708. Weight module 708 may be the same or similar to any weight module described herein. Weight module 708 may be a single continuous weight module formed from concrete or other relatively dense material. In various embodiments, weight module 708 may be a simple block of material. In various embodiments, weight module 708 may be formed from concrete, metal or metal alloys, composites, or one or more rubber materials. In various embodiments, weight module 708 may be one or more containers configured to hold sand, water, gravel or another material. In various embodiments, weight module 708 may have any dimensions and any geometric shape. One of skill in the art would appreciate that weight module 708 is depicted as a rectangular prism or box shape, but this does limit the overall dimensions or geometries described herein. In various embodiments, weight module 708 may include one or more electricity-generating components as described herein. In various embodiments, the electricity-generating components may be operatively coupled to belt 704. In various embodiments, weight module 708 may include one or more electric motors configured to locomote the weight module 708 up or down the belt loop, between belt loops (as shown in the right-hand side of FIG. 14A) or vice versa, wherein the belt loops are configured to translate or roll along the longitudinal dimension of a relatively stationary weight module 708.

Referring specifically to FIG. 14B, LDCS 700 may include a bearing channel 705. Bearing channel 705 may be affixed to weight module 708. In various embodiments, bearing channel 705 may be planar walls extending from a lateral side of weight module 708, defining an interwall spacing. In various embodiments, bearing channel 705 may be any dimension, depicted herein as two opposite and opposing planar walls surrounding the lateral sides of belt 704, shown in a cutoff-view. In various embodiments, bearing channel 705 may be affixed to weight module 708 via one or more mechanical fasteners, such as a series of bolts extending along the walls of the bearing channel 705. In various embodiments, bearing channel 705 may be integral to weight module 708 and formed as one continuous component. In various embodiments, the profile of bearing channel 705 may be planar or arcuate. In various embodiments, bearing channel 705 may extend from weight module 708 the approximate length of the bearings disposed within, as will be described herein below.

In various embodiments, bearing channel 705 may house a plurality of stationary bearings 712. Stationary bearings 712 may be cylindrical roller bearings, depicted as having planar circular termini, each stationary bearing 712 extending within bearing channel 705 perpendicular to the planar surface of the weight module 708. In various embodiments, stationary bearings 712 may be cylindrical components that do not roll relative to the bearing channel 705. In various embodiments, stationary bearings 712 may be coupled to the bearing channel 705. In various embodiments, stationary bearings 712 may be coupled directly to weight module 708. In various embodiments, stationary bearings 712 may be coupled to one or more casings such as a slotted section (as will be described below). In various embodiments, each stationary bearing 712 may be rotatable coupled within bearing channel 705 and configured to rotate or roll relative to the bearing channel 705. In various embodiments, stationary bearings 712 may be configured to translate along the bearing channel 705, to a degree. In various embodiments, bearings 712 may be elastically coupled within bearing channel 705 and configured to translate perpendicular to their longitudinal axis when acted upon by a force, returning to their neutral position when that force is relieved. In various embodiments, stationary bearings 712 may be disposed in a vertical periodic line proximate either wall of bearing channel 705, as shown in FIG. 14B. In various embodiments, stationary bearings 712 may be configured to have a specific coefficient of friction, thereby rotating a certain radial distance when contacted by another roller bearing. In various embodiments, stationary bearings 712 may be disposed a distance from each wall of channel 705 such that the cylindrical surface of the bearing is contacting the wall. In various embodiments, stationary bearings 712 may be rigidly coupled to the bearing channel 705 or weight module 708 such that no translation of the stationary bearings 712 occurs.

In various embodiments, LDCS 700 includes moveable bearings 716. Moveable bearings 716 may be similarly constructed as stationary bearings 712. Moveable bearings 716 may be cylindrically shaped, having a rolling surface forming a cylindrical sidewall, terminating in planar circular ends. Each moveable bearing 716 may include a parallel cylindrical axis to the plurality of stationary bearings 712. Moveable bearings 716 may be configured to translate laterally relative to the bearing channel 705, that is the moveable bearings 716 may move towards and away from the channel walls. In various embodiments, moveable bearings 716 may have a neutral position interior to the stationary bearings 712. In various embodiments, moveable bearings 716 may be offset vertically form the plurality of stationary bearings 712 such that contact with the stationary bearings 712 by the moveable bearings occurs at a diagonal point between the cylinders. The generally diagonal contact point can be seen on the left hand side of FIG. 14B. Moveable bearings 716 may be spaced apart in bearing channel 705 forming two generally vertical rows of moveable bearings 716 spaced generally between each pair of stationary bearings 712. Moveable bearing 716 may be laterally translatably fixed within bearings channel 705 such that the first thickness of belt 704 may pass between the moveable bearings 716 without contacting or without displacing moveable bearings 716. In various embodiments, the plurality of moveable bearings 716 may be coupled to the weight module 708. In various embodiments, moveable bearings 716 may be coupled to or within one or more casings, such as slotted section 720 (as discussed below). In various embodiments, the neutral position of moveable bearings 716 may allow the belt to pass with only rolling of the moveable bearings affected by the passing belt 704. In various embodiments, moveable bearings 716 may be disposed within a distance from the belt 704 that the bulge of the belt 704 fully contacts the moveable bearings 716 on either side of the belt. Moveable bearings 716 may be configured to translate outward in response to the force of the bulges being forced past said moveable bearings 716. The moveable bearings 716 may roll over the bulge of belt 704 and be forced out of their neutral position and outward toward the bearing channel walls and the stationary bearings 712. As the bulge passes through the moveable bearings 716, the greater thickness of the bulge may press the moveable bearings into diagonal contact with the stationary bearings 712, thereby transmitting an outward lateral force to affect a vertical translation of the stationary bearings 712 relative to the moveable bearing 716. As the belt 704 moves upward or downward, the contact between the moveable bearings 716 and the stationary bearings 712 may affect the stationary bearings 712 and therefore the weight module 708 affixed thereto to translate upwards or downwards along the direction of movement of the belt 704. One of skill in the art would appreciate that the relative arrangement of the bearings, that is to say the contact point between the moveable bearings 716 and the stationary bearings 712 may force the stationary bearings upwards or downwards as they roll over the moveable bearings 716. In this manner, downward motion of the belt 704 may affect upwards motion of the weight module 708.

In various embodiments, the weight module 708 may be acted upon by gravity, thereby forcing the stationary bearings 712 into contact with the moveable bearings 716 that have been forced outward from contact with the bulge of the belt 704. This contact may affect opposite motion in the belt 704, thereby locomoting the belt 704 within the bearing channel 705 through the force of gravity. In various embodiments, the belt 704 may in turn rotate another component in the system that is not shown, for example the rotor of an electric generator, thereby generating electricity in response to the force of gravity. In various embodiments, the belt 704 may be configured to affect motion of the weight module 708 in the same direction as the locomotion of the belt 704. For example and without limitation, the moveable bearings 716 may be configured to contact the stationary bearings 712 disposed exterior and below them, such that as the belt moves downward, the bulge forces the moveable bearings 716 outward and into contact with the interior upper surface of the stationary bearings, thereby forcing the stationary bearings 712 downward and the weight module 708 with it. The weight module 708 in this example would lower at a rate slower than the locomotion of the belt 704, as the belt 704 only contacts the moveable bearings 716 at the bulge points. This arrested downward motion of the weight module 708 would be akin to a regenerative braking, where the belt 704 moves at a first speed, and the weight module 708 moves at a second speed in the same direction. In various embodiments, the weight module 708 or a portion of the bearing channel may be affixed to a pulley or other rotatably component, such as a rotor of an electric motor. In various embodiments, the belt 704 may move upward through the bearing channel 705, thereby forcing the weight module 708 up in the reverse manner as described above. One of skill in the art would appreciate that the relative arrangement of the stationary bearings 712 and the moveable bearings 716 may define the direction of motion of the belt 704 and the weight module 708, and this disclosure does not seek to limit the direction or relative direction of the components in the system.

Referring now to FIG. 14C, an exemplary depiction of stationary bearings 712 and movable bearings 716 can be seen extending in generally vertical rows, with the bearing channel 705 and weight module removed for clarity. In various embodiments, the moveable bearings 716 may alternatively be disposed outward of the stationary bearings 712. In various embodiments, each the moveable bearings 716 may be grouped in pairs that are laterally aligned along the bearing channel 705. LDCS 700 may include a slotted section 720.

Slotted sections 720 may be generally planar components extending around the array of stationary bearings 712 and moveable bearings 716. In various embodiments, each slotted section 720 may include a include a slot laterally cut through a planar box shaped component. The slot may be generally rectilinear and extending around the terminal ends of the bearing array. In various embodiments, the slot may be any dimension and with any profile, including squared, as shown or arcuate. In various embodiments, slotted sections 720 may be configured to retain a roller bearing such as moveable bearings 716. In various embodiments, there may be a single slotted section 720 retaining each set of moveable bearings 716. In various embodiments, a subset of the plurality of moveable bearings 716 may be retained within a slotted section 720. In various embodiments, slotted sections 720 may be configured to translate along the longitudinal axis of the bearing channel 705. In various embodiments, the moveable bearings 716 may be configured to impart an upward or downward force from the belt 704 onto the slotted section 720, or vice versa.

In various embodiments, as slotted section 720 moves along the bearing channel 705, an internal profile of the slotted section 720 may pinch the moveable bearings 716 inward towards belt 704. The moveable bearings 716 may impart a force on the belt 704, thereby running the system as described in reverse, or to brake the motion of the slotted section 720 along the belt 704 or bearing channel 705. In various embodiments, the slotted section 720 may be configured to locomote continuously or in a wave or crawling motion. In various embodiments the slotted sections 720 may include any slot shape, such as arcuate or angled, horizontal or other shape. Slotted sections 720 may be configured to react to the upward or downward force from the moveable bearings 716 based on lateral location within the channel. In various embodiments, the arcuate or angled slots of slotted sections 720 may serve to reduce the relative motion of adjacent slotted sections 720. In various embodiments, the angled slots of slotted sections 720 may reduce or eliminate the relative motion of adjacent slotted sections 720, thereby eliminating any pulsing effect or wavelike motion of the collective slotted sections 720.

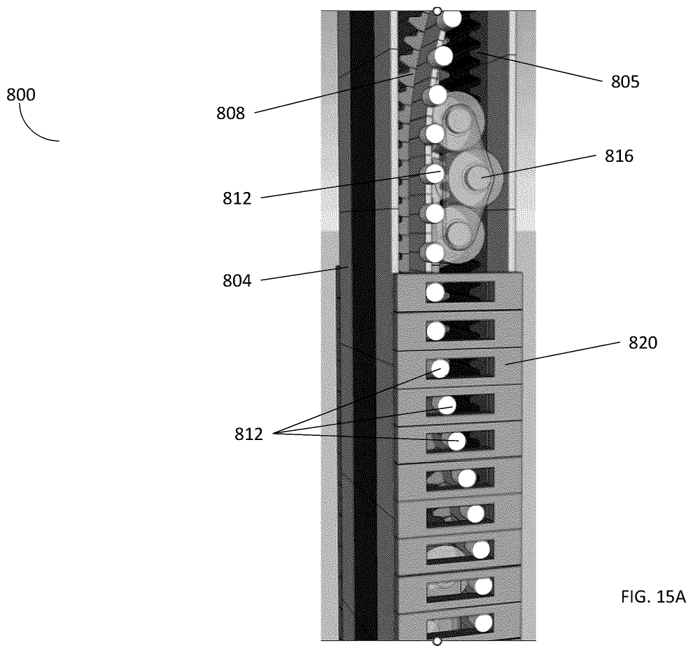

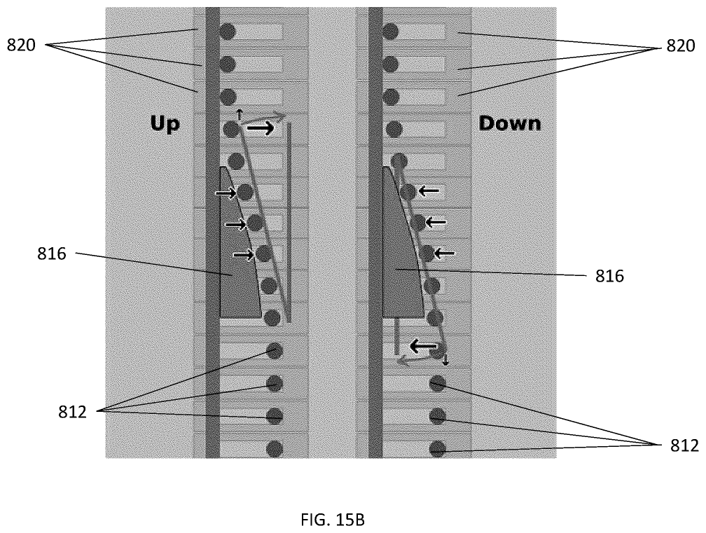

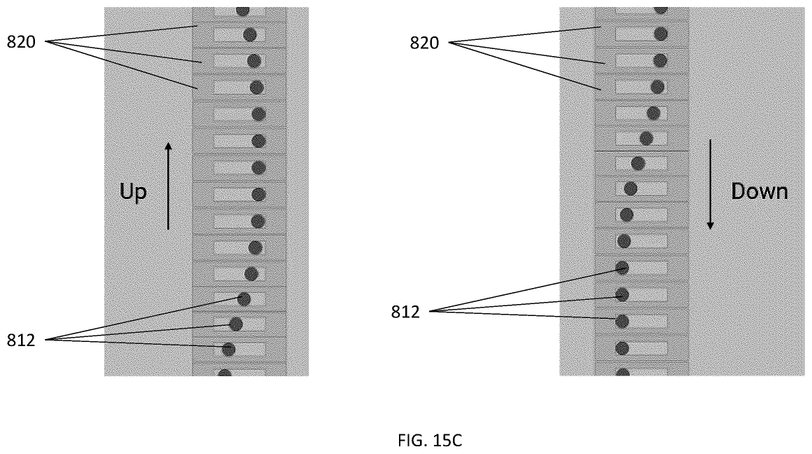

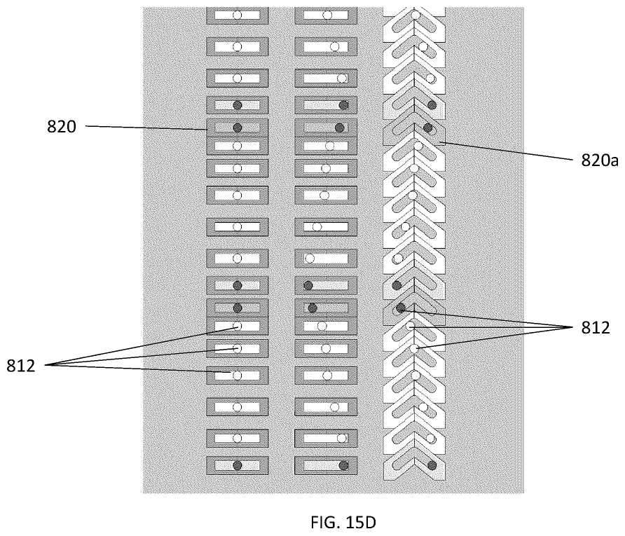

Referring now to FIG. 15A-15D, an embodiment of LDCS 800 is shown in perspective and orthogonal schematic views. LDCS 800 may include a bearing channel 804. Bearing channel 804 may be the same or similar to bearing channel 705 as described above. Bearing channel 804 may be affixed to weight module. In various embodiments, bearing channel 804 may be planar walls extending from a lateral side of weight module, defining an interwall spacing. In various embodiments, bearing channel 804 may be any dimension, depicted herein as two opposite and opposing planar walls surrounding the lateral sides of a toothed belt, shown in a cutoff-view. In various embodiments, bearing channel 804 may be affixed to weight module via one or more mechanical fasteners, such as a series of bolts extending along the walls of the bearing channel 804. In various embodiments, bearing channel 804 may be integral to a weight module and formed as one continuous component. In various embodiments, the profile of bearing channel 804 may be planar or arcuate. In various embodiments, bearing channel 804 may extend from the weight module the approximate length of the bearings disposed within, as will be described herein below. In various embodiments, bearing channel 804 may include toothed sections 805 disposed on both channel walls, the teeth 805 disposed opposite and opposing to one another, such that the peaks of the teeth are oriented toward the interior of the bearing channel 804. In various embodiments, the teeth 805 may be mirror images symmetrical disposed about the centerline of the bearing channel 804. In various embodiments, the teeth 805 may be laterally symmetric or offset to one another, such that the vertical position of a first tooth on one toothed section is disposed in a valley of the opposite toothed section 805. In various embodiments, a first toothed section 805 may include teeth of varying geometry relative to the oppositely disposed toothed section. In various embodiments, the teeth on both toothed sections 805 may be identical and opposite.

In various embodiments the toothed sections 805 may extend along the entire length of bearing channel 804 or a portion thereof. In various embodiments, toothed sections 805 may extend for periodic vertical sections of the bearing channel 804. In various embodiments the tooted section 805 may be disposed in paired sections, wherein opposing toothed sections 805 are laterally disposed about the same vertical section of bearing channel 804. In various embodiments, the toothed sections 805 may be alternatingly disposed on opposite walls of bearing channel 805, wherein each toothed section 805 faces an interior wall of bearing channel 804 having no teeth.

In various embodiments, LDCS 800 includes a toothed belt 808. Toothed belt 808 may include a generally planar center portion extending longitudinally within bearing channel 804. In various embodiments, toothed belt 808 may include a plurality of teeth, akin to gears, extending from said planar portion outward towards the interior walls of bearing channel 804. In various embodiments, toothed belt 808 may be configured to mesh with at least one toothed section 805. In various embodiments, toothed belt 808 may be configured to mesh with both toothed sections 805 simultaneously or alternatingly. In various embodiments, toothed belt 808 may be configured to bend within bearing channel 804. In various embodiments, toothed belt 808 may be configured to bend in a serpentine motion such that a first portion of the toothed belt comes into contact with a first toothed section 805 on a first wall of the bearing channel 804 as a section portion of toothed belt 808 meshes with the opposite toothed section 805 on the second wall of bearing channel 804. In various embodiments, toothed belt 808 may be configured to alternatingly mesh with both toothed sections 805 successively. In various embodiments, toothed belt 808 may be configured to mesh with the teeth of the toothed section 805 and exert a longitudinal force on the bearing channel 804, thereby locomoting relative to the bearing channel 804, or vice versa. In various embodiments, the toothed belt 808 may be biased to bend in alternating sections, such that a first portion of toothed belt 808 bends toward a first wall, an adjacent portion of toothed belt 808 bends in the opposite direction towards the second wall. In various embodiments, toothed belt 808 may have laterally symmetric teeth or laterally offset teeth.

In various embodiments, toothed belt 808 may include a plurality of roller bearings 812 disposed at either end of the centerline planar portion of the belt, extending parallel to the walls of the bearing channel 804. Roller bearings 812 may include a cylindrical surface circumscribing a transverse axis relative to the toothed belt 808. In various embodiments, the roller bearings 812 may be configured to rotate relative to the center of the toothed belt 808. In various embodiments, the vertical location of the roller bearings 812 may be stationary relative to the toothed belt 808, such that the roller bearings translate laterally as the toothed belt 808 serpentines. In various embodiments there may be a degree of play between the roller bearings 812 and the toothed belt 808 such that the roller bearing 812 is biased back to a neutral position on the toothed belt 808 when not acted upon by gravity or one of the drivers 816, as will be described below.

Referring specifically to FIGS. 15A and 15B, LDCS 800 may include at least one driver 816. In various embodiments, each driver 816 may include wheels configured to contact the interior wall of bearing channel 804. In various embodiments, each driver 816 may be configured to have any number of wheels, at least a subset of the wheels configured to contact the interior walls of bearing channel 804. In various embodiments, each driver 816 may be configured to mesh with a portion of the toothed belt 808 or toothed sections 805. In various embodiments, there may be any number of drivers 816 disposed within bearing channel 804. In various embodiments, a first driver 816 may be configured on a first side of toothed belt 808, and a second driver 816 may be disposed on the second and opposite side of toothed belt 808. In various embodiments, each driver 816 may be configured to trail or precede an adjacent driver 816. In various embodiments, each driver 816 may be configured to travel in the same direction with bearing channel 804. In various embodiments, each driver 816 may be configured to travel within bearing channel 804 at approximately the same speed. In various embodiments, each driver 816 may be configured to travel within bearing channel 804 under its own onboard power, for example with an electric motor rotatably coupled to at least a wheel of the driver 816. In various embodiments, each driver 816 may be configured to collectively travel through the bearing channel 804 via an external actuator, such as commonly affixed to one or more pulleys and ascending or descending the bearing channel 804. In various embodiments, each driver 816 may be configured to travel downward through a vertically oriented bearing channel 804 under the power of gravity.

With continued reference to FIGS. 15A and 15B, drivers 816 may be configured to contact each side of toothed belt 808. For example and without limitation, each driver 816 may be configured to roll between the wall of bearing channel 804 and toothed belt 808, forcing toothed belt 808 away from the bearing channel 804 wall. In various embodiments, one or more wheels of driver 816 may be configured to simultaneously contact the toothed belt 808 an the bearing channel 804, forcing the toothed belt 808 into contact with the opposite wall of bearing channel 804. For example, and without limitation, the driver 816 may be configured to force the toothed belt 808 into contact with the opposite wall of bearing channel 804, thereby meshing the toothed belt 808 into the toothed section 805 oppositely disposed from the driver 816. In various embodiments, the toothed belt 808 may be configured to serpentine in response to the at least one drivers 816. For example and without limitation, a first and second drivers 816 may travel through the bearing channel 804, alternatingly forcing the toothed belt 808 back and forth into mesh points on either interior wall of bearing channel 804, thereby crawling the toothed belt 808 up or down the bearing channel 804. Alternatively or additionally, the drivers 816 may be configured to locomote the toothed belt down the bearing channel 804 in an opposite direction.

With continued reference to FIGS. 15A-15C, LDCS 800 includes a plurality of channeled sections 820. Slotted sections 820 may be generally planar components extending between the walls of the bearing channel 804. Slotted sections 820 may extend between the terminal sides of the bearing channel 804 walls. In various embodiments, slotted sections 820 may extend a portion of the distance between the walls of the bearing channel 804. In various embodiments, each slotted section 820 may include a include a slot laterally cut through the planar component. The slot may be generally rectilinear and extending between the walls of the bearing channel 804. In various embodiments, the slot may be any dimension and with any profile, including squared, as shown or arcuate. In various embodiments, slotted sections 820 may be configured to retain a roller bearing 812. In various embodiments, there may be a single slotted section 820 retaining each roller bearing 812. In various embodiments, a subset of the plurality of roller bearings 812 may be retained within a slotted section 820. In various embodiments, slotted sections 820 may be configured to translate along the longitudinal axis of the bearing channel 804. In various embodiments, the roller bearings 812 may be configured to impart an upward or downward force from the toothed belt 808 onto the slotted section 820.

For example, as the toothed belt 808 serpentines between the toothed sections 805, it locomotes along the bearing channel 804, as the toothed belt 808 serpentines, the roller bearings 812 move laterally within the slotted section 820, as the roller bearing 812 moves laterally within the slotted sections 820, an additional upward or downward force (in the direction of belt movement) is imparted to the slotted channels, locomoting said slotted channels 820 along the bearing channel 804. In various embodiments, the slotted channels 820 are configured to locomote continuously or in waves. For example, as shown in FIG. 15B, the upward force of the roller bearings 812 is imparted on the slotted channels 820 in response to the driver 816 moving behind the toothed belt 808. In various embodiments, the system may operate in reverse, shown on the right hand side of FIGS. 15B and 15C, a downward force is imparted to the slotted channels 820 as the driver 816 moves downward, forcing the toothed belt 808 to serpentine within bearing channel 804 and moving downwards.

As shown in FIG. 15D, the slotted sections 820 may include any slot shape, such as arcuate or angled, as shown by slotted sections 820a. Slotted channels 820a may be configured to react to the upward or downward force from the roller bearings 812 based on lateral location within the angled channel of 820a. In various embodiments, the arcuate or angled slots of slotted sections 820a may serve to reduce the relative motion of adjacent slotted sections 820, an example of the variable inter-slotted section 820 distance is shown on the left hand side of FIG. 15D. In various embodiments, the angled slots of slotted sections 820a may reduce or eliminate the relative motion of adjacent slotted sections 820a, thereby eliminating any pulsing effect or wavelike motion of the collective slotted sections 820a. One of skill in the art would appreciate that the interplay of the serpentine motion of the toothed belt 808, and therefor the serpentine relative position of the roller bearings 812 interacting with the slots of slotted sections 820a may define the speed and step of any collective motion of the slotted sections 820a. In various embodiments, the slotted sections 820a may move together as there is no relative displacement of any single slotted section 820a relative to another. Each slotted channel 820 or 820a may be affixed to a weight module as described herein.

As described above, the weight module may be the same or similar to any weight module described herein. The weight module may be a single continuous weight module formed from concrete or other relatively dense material. In various embodiments, the weight module may be a simple block of material. In various embodiments, the weight module may be formed from concrete, metal or metal alloys, composites, or one or more rubber materials. In various embodiments, the weight module may be one or more containers configured to hold sand, water, gravel or another material. In various embodiments, the weight module may have any dimensions and any geometric shape. In various embodiments, the weight module may include one or more electricity-generating components as described herein. In various embodiments, the electricity-generating components may be operatively coupled to toothed belt 808. In various embodiments, the weight module may include one or more electric motors configured to locomote the weight module up or down the belt or bearing channel 804, between belt or vice versa.

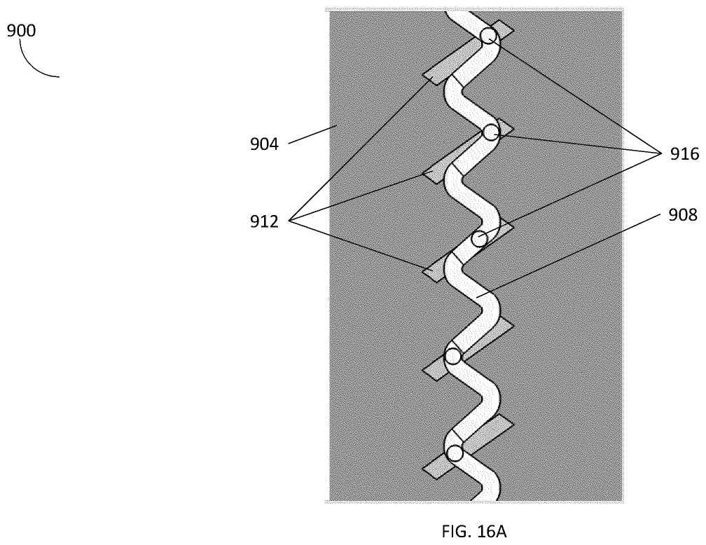

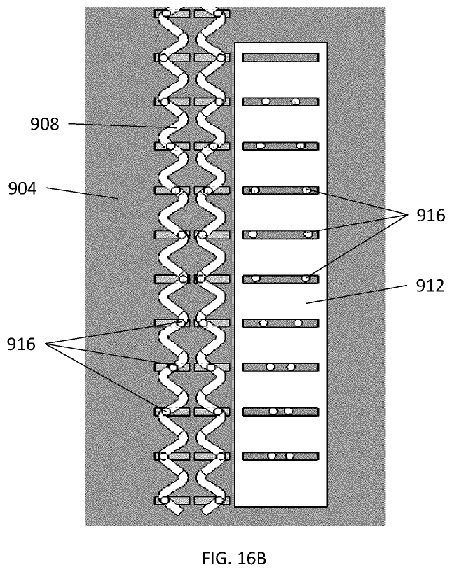

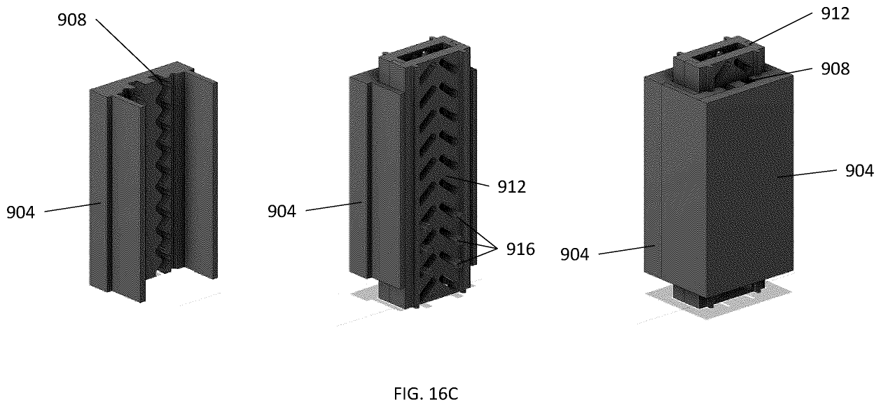

Referring now to FIG. 16A-16C, an embodiment of LDCS 900 is shown in schematic and perspective views. LDCS 900 may include a rack 904. Rack 904 may be a planar component have a first side and a second side, defining a thickness therebetween. Rack 904 may have a generally rectilinear shape having opposite and opposing straight edges. In various embodiments, rack 904 may be any shape and have any dimensions. The rack 904 may be configured to couple to a weight module (not shown). As described above, the weight module may be the same or similar to any weight module described herein. The weight module may be a single continuous weight module formed from concrete or other relatively dense material. In various embodiments, the weight module may be a simple block of material. In various embodiments, the weight module may be formed from concrete, metal or metal alloys, composites, or one or more rubber materials. In various embodiments, the weight module may be one or more containers configured to hold sand, water, gravel or another material.

In various embodiments, the weight module may have any dimensions and any geometric shape, including having a planar surface having the same shape and dimension as rack 904. In various embodiments, the weight module may include one or more electricity-generating components as described herein. In various embodiments, the electricity-generating components may be operatively coupled to one or more roller bearings, slots, or another component described herein below. In various embodiments, the weight module may include one or more electric motors configured to locomote the weight module up or down the bearing channel 908, which will be described herein below.

In various embodiments, rack 904 may include a bearing channel 908. Bearing channel 908 may extend a portion of the vertical dimension of rack 904. In various embodiments, bearing channel 908 may have any planform shape, for example a diagonally alternating or serpentine shape as depicted in FIGS. 16A-16C. In various embodiments, bearing channel 908 may be a linear or substantially linear channel extending vertically and parallel to the lateral edges of rack 904. In various embodiments, bearing channel 908 may include the serpentine shape with normal corners meeting at right angles. In various embodiments, bearing channel 908 may include gradually turning corners having a radius, as shown in FIG. 16A.

In various embodiments, bearing channel 908 may be disposed at an angle to the rack 908, for example diagonally across rack 908, extending from a left or right upper corner to a bottom left or right opposite lower corner. In various embodiments, bearing channel 908 may be disposed horizontally relative to the rack 904. In various embodiments, bearing channel 908 may travel any path between a starting point and ending point, for example, the bearing channel 908 may have a starting point proximate an upper edge of rack 904, trace an arcuate or any path between an ending point proximate the lower edge of rack 904.

With continued reference to FIG. 16A, LDCS 900 may include a series of slotted sections 912. Slotted sections 912 may be disposed at an angle to rack 904. Slotted sections 912 be disposed adjacent to an abutting a planar surface of rack 904. In various embodiments, slotted sections 912 may be similar to any slotted section as described herein. Slotted sections 912 may be generally planar components extending between the lateral edges of rack 904. Slotted sections 912 may extend between the terminal sides of the rack 904 walls (not shown). In various embodiments, slotted sections 912 may extend a portion of the distance between the walls of the rack 904. In various embodiments, each slotted section 912 may include a include a slot laterally or substantially laterally cut through a planar component transverse to the general direction of bearing channel 908. The slot may be generally rectilinear and extending between the edges of the rack 904. In various embodiments, the slot may be any dimension and with any profile, including squared, as shown, or arcuate.

In various embodiments, slotted sections 912 may be configured to retain a roller bearing 916. In various embodiments, there may be a single slotted section 912 retaining each roller bearing 916. In various embodiments, a subset of the plurality of roller bearings 916 may be retained within a slotted section 912. In various embodiments, slotted sections 912 may be configured to translate along the longitudinal axis of the bearing channel 908. In various embodiments, the roller bearings 916 may be configured to impart an upward or downward force from the slotted sections 912 onto the rack 904, or vice versa. In various embodiments, the slotted sections 912 may be affixed to the weight module described above.

For example, as the slotted channels 912 locomote upward or downward along the rack 904, the roller bearings 916 move laterally within the slotted section 912, as the roller bearing 916 moves laterally within the slotted sections 912, an additional upward or downward force (in the direction of belt movement) is imparted to the slotted channel 908, locomoting said slotted channels 912 along the bearing channel 908.

In various embodiments, the slotted sections 912 are configured to locomote continuously or in waves. For example, as shown in FIG. 16A, the upward force of the roller bearings 916 is imparted on the slotted sections 912 in response to the rack 904 moving, for example under the force of gravity. In various embodiments, the system may operate in reverse, wherein a downward force is imparted to the slotted channels 912 as rack 904 moves downward, forcing the roller bearings 916 simultaneously serpentine within bearing channel 908 while moving laterally within slotted sections 912.

As shown in FIGS. 16A-16B, the slotted sections 912 may include any slot shape, such as angled or horizontal. Slotted channels 912 may be configured to react to the upward or downward force from the roller bearings 916 based on lateral location within the slotted section 912. In various embodiments, the arcuate, angled or horizontal slots of slotted sections 912 may serve to reduce the relative motion of adjacent slotted sections 912. One of skill in the art would appreciate that the interplay of the serpentine motion of the roller bearings 916 within the slots of slotted sections 912 may define the speed and step of any collective motion of the slotted sections 912 or rack 904. In various embodiments, the slotted sections 912 may move together as there is no relative displacement of any single slotted section 912 relative to another. Each slotted channel 912 may be affixed to a weight module as described herein.

Referring specifically to FIG. 16B-16C, LDCS 900 may include two distinct and oppositely angled bearing channels 908. As shown in FIG. 16B, the bearing channels 908 may be mirror images of one another, such that the interior angles and outward angles of the bearing channels 908 are disposed at the same vertical position in the rack 904. In various embodiments, there may be two roller bearings disposed in the slotted section 912, here shown as a continuous component with a plurality of parallel and periodic slots. Each of the two roller bearings 916 may commonly disposed in a slot of the slotted section 912. As the bearings travel within the serpentine bearing channels 908, the roller bearings 916 translate inward and outward within the slot of slotted sections 912 simultaneously. As the roller bearings 916 translate within the slot, the force of the angled bearing channel 908 pressing on the bearings exerts a force through said bearing on to the slotted section 912. As was discussed above, this system may be operated in reverse, wherein a weight module affixed to either of the slotted section 912 or the rack 904 forces said component downward, force is transferred through the bearings to the bearing channels 908, forcing said rack 904 downward. Additionally or alternatively, rack 904 and slotted section 912 may be configured to arrest the slide of the other under the force of gravity. For example and without limitation, the slotted section 912 may be acted upon by gravity, thereby forcing the two roller bearings 916 downward through the bearing channels 908, the force of the bearings sliding within the angled portions of bearing channels 908, thereby arresting the motion of the slotted section 912 moving downward. As was discussed above, either of the rack 904 or the slotted section 912 may be affixed to a weight module or coupled to an electricity-generating component. For example and without limitation, the slotted section 912, as it moves downward and arrested by the rack 904, may turn a rotor of an electric motor or electric generator. In reverse, the slotted section 912 may be raised by an electric motor operatively coupled thereto, forcing the bearings 916 through the bearing channels 908 of rack 904, thereby setting up for a subsequent dropping and generation of electricity through gravity.

In various embodiments, any weight module described herein may be configured to absorb, store and release thermal energy, as described in U.S. patent application Ser. No. 17/237,048, the entire contents of which are hereby incorporated by reference in their entirety. This could be accomplished by the module being adapted to absorb, release, and/or hold some form of thermal material, such as thermal gas or liquid which may be filled and unfilled. Likewise, a modular solid component adapted to store, absorb, and release thermal energy may be attached and detached. The thermal material may be strategically located in the presence of varying thermal environments in order to charge and discharge thermal energy. For example, a module may be dropped underground where the underground temperature is different from the ambient temperature above ground.

Similarly, the module could be adapted to hold a pressurized and/or refrigerated tank of liquid air. As explained below, this air can be utilized in a cycle which leverages natural geothermal heat in order to help lift some of the system's weight, and this can increase the system's overall efficiency. In such a system, when above ground, the system expends energy to convert the air into a liquid by reducing its temperature and/or by increasing its pressure (as understood through the ideal gas law). This makes the air dense as it turns into a liquid. Then, below ground, the air is released into the shaft where it can come into contact with the shaft walls with geothermal temperatures.

If the liquid air was not already cold and depressurized, it will become cold as it is depressurized as understood by the ideal gas law. As this cold air comes into contact with the shaft walls which are comparatively very hot, the air will be heated again. This heat lifts the air and creates extra air pressure at the top of the shaft which can be captured into power again. For example, this pressurized air can be passed through a turbine generator. Additionally, since the modules are now lighter-having emptied the heavy compressed air, there is less weight to lift than they had when generating power on the way down. As is evident, even though both gravitational energy storage and compressed air energy storage have some inefficiency (they lose some energy over the course of their cycle)-by combining them in this way, the efficiency of both is improved by utilizing natural geothermal heat. The gravitational energy benefits from the cycle of the air gaining and losing weight. The compressed air energy storage benefits from the temperature differential as it's translated between one natural temperature and another.

The modular energy storage system which may utilize any combination of the presently disclose LDCSs may further include a secondary energy storage device such as a flywheel, a battery, or some other device to smooth out the system's power load profile and/or to supplement the installation's power capacity. In various embodiments, it may be desirable for the facility to absorb or disperse some amount of power to or from these secondary energy storage devices in order to smooth out dips or surges in the facility's power load profile for some amount of time. For example when the system is initially starting or stopping its discharge cycle, it may be not possible or practical to ramp up or ramp down the power load profile exactly as desired with gravity storage alone.

This secondary energy storage system could be partially or fully distributed and integrated into the LDCS systems or weight modules themselves. For example, some amount of the weight module could be comprised of a heavy flywheel or a heavy chemical battery.

In various embodiments, any actuator, storage system, weight module, bearing, toothed component, LDCS or portion thereof, may be appropriately adapted for use in any system described herein.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A linear drive conveyance system, the system comprising:
a rack having
a first end and a second end, defining a longitudinal axis therebetween, the rack having,
at least one undulating surface, the undulating surface having a plurality of alternating arcuate peaks and valleys spaced along the longitudinal axis;
a finger opposing the undulating surface of the rack, the finger having
cylindrical head disposed perpendicular to the longitudinal axis, the cylindrical head having two planar ends circumscribed by a cylindrical sidewall
at least one pin extending from each of the planar ends of the cylindrical head
a follower having a cylindrical sidewall abutting perpendicularly to and at a midpoint of the cylindrical head
a cam disposed opposite of the follower from the cylindrical head, the cam having an asymmetrical cam profile, the cam configured to rotate about a cam axis extending perpendicularly to and spaced from the longitudinal axis; and
a camshaft rigidly coupled to the cam, the camshaft extending along the longitudinal axis.

2. The linear drive conveyance system of claim 1, wherein the cam is configured to abut the follower along the cam profile.

3. The linear drive conveyance system of claim 1, wherein the cylindrical head of the finger is configured to contact at least one of the plurality of valleys of the rack.

4. The linear drive conveyance system of claim 1, wherein the camshaft is configured to rotate with the cam.

5. The linear drive conveyance system of claim 1, wherein the follower is rigidly coupled to the cylindrical head of the finger.

6. The linear drive conveyance system of claim 1, wherein the follower comprises planar ends disposed perpendicularly to the cylindrical sidewall, the follower further comprising at least one pin extending concentrically form the planar ends.

7. The linear drive conveyance system of claim 1, wherein the finger is mechanically biased towards the cam.

8. The linear drive conveyance system of claim 1, wherein the undulating surface of the rack comprises a sine wave profile having a peak height and a valley depth, the peak height being equal to the valley depth.

9. The linear drive conveyance system of claim 1, wherein the undulating surface extends laterally along the rack terminating at lateral edges of the rack.

10. The linear drive conveyance system of claim 1, wherein the finger is configured to be actuated toward the camshaft by the undulating surface translating along the longitudinal axis.

11. The linear drive conveyance system of claim 1, wherein the finger is configured to actuated toward the rack by rotation of the cam shaft.

12. The linear drive conveyance system of claim 1, comprising a plurality of fingers spaced along and disposed opposing the undulating surface of the rack.

13. The linear drive conveyance system of claim 1, further comprising a plurality of cams, each cam disposed adjacent to the follower of the plurality of fingers, each cam disposed axially along the cam axis and coupled to the camshaft.

14. The linear drive conveyance system of claim 1, wherein each cam of the plurality of cams is angularly offset about the camshaft relative to an adjacent cam.

15. The linear drive conveyance system of claim 1, wherein each finger of the plurality of fingers are mechanically biased into contact with the plurality of cams.

16. The linear drive conveyance system of claim 1, wherein the rack is configured to translate along the longitudinal axis, contacting the plurality of fingers with alternating peaks and valleys, forcing the plurality of fingers into turning the cam coupled thereto, thereby turning the camshaft.

17. The linear drive conveyance system of claim 1, wherein the camshaft is rotatably coupled to an actuator.

18. The linear drive conveyance system of claim 1, wherein the actuator is an electric motor, the camshaft rotatably coupled to a rotor of the electric motor.

19. The linear drive conveyance system of claim 1, wherein the camshaft is rotatably coupled to an electric generator, the camshaft coupled to a rotor of the electric generator.

20. The linear drive conveyance system of claim 1, wherein the rack is affixed to a weight module.

21. The linear drive conveyance system of claim 1, further comprising a load bearing element configured to affix the camshaft to a shaft.

22. The linear drive conveyance system of claim 1, wherein the shaft is a substantially vertical shaft disposed underground.

23.-55. (canceled)
